(19) United States
(12) Patent Application Publication
(10) Pub. No.: US 2020/0265486 A1
(43) Pub. Date: Aug. 20, 2020

(54) PURCHASE SUPPORT APPARATUS, PURCHASE SUPPORT TERMINAL, AND PURCHASE SUPPORT SYSTEM

(71) Applicant: NEC CORPORATION, Tokyo (JP)

(72) Inventor: Shigeharu SAKAYORI, Tokyo (JP)

(73) Assignee: NEC CORPORATION, Tokyo (JP)

(21) Appl. No.: 16/651,910

(22) PCT Filed: Sep. 13, 2018
(86) PCT No.: PCT/JP2018/034074

§ 371 Date: Mar. 27, 2020

(30) Foreign Application Priority Data
Sep. 29, 2017 (JP) 2017-190393

(51) Int. Cl. G06Q 30/02; G06Q 10/08

(52) U.S. Cl. CPC G06Q 30/0283; G06Q 10/087; G06Q 30/0206

(57) ABSTRACT

Provided is a purchase support apparatus, a purchase support terminal, and a purchase support system by which a user can make a purchase at a timing when wishing to make a purchase. The purchase support apparatus includes: a price determination unit that compares a requested purchase price of an article registered by a user with a selling price at a shop of the article and determines whether or not the selling price is lower than or equal to the requested purchase price; and a notification unit that, when it is determined by the price determination unit that the selling price is lower than or equal to the requested purchase price, notifies the user of information regarding the selling price and the shop.

### TECHNICAL FIELD

The present invention relates to a purchase support apparatus, a purchase support terminal, and a purchase support system that support a purchase of an article.

### BACKGROUND ART

In the modern consumption society, cycles in which articles are purchased and consumed are repeated. When purchasing an article, it is necessary to consider various factors such as a list of articles, expensiveness or inexpensiveness of the article, stock status, a shop for the purchase, a timing of the purchase, or the like, for example.

Patent Literature 1 discloses a shopping support apparatus having an analysis unit that analyzes a purchase record based on an electronic receipt or the like including a purchase history of an item and a shopping list generation unit that generates a shopping list candidate including candidates of items to be purchased based on a result of analysis performed by the analysis unit.

### CITATION LIST

### Patent Literature

PTL 1: Japanese Patent Application Laid-Open No. 2016-218835

### SUMMARY OF INVENTION

### Technical Problem

For a person who wishes to purchase an article, it is preferable to purchase an intended article at a lower price in terms of economics. However, since the price of an article may vary and, even for the same article, the price thereof may be different between shops, it is not easy to purchase the article at a lower price. Thus, it is not easy for a user to purchase an item at a timing when wishing to make a purchase.

The present invention intends to provide a purchase support apparatus, a purchase support terminal, and a purchase support system by which a user can make a purchase at a timing when wishing to make a purchase.

### Solution to Problem

According to one example aspect of the present invention, provided is a purchase support apparatus including: a price determination unit that compares a requested purchase price of an article registered by a user with a selling price at a shop of the article and determines whether or not the selling price is lower than or equal to the requested purchase price; and a notification unit that, when it is determined by the price determination unit that the selling price is lower than or equal to the requested purchase price, notifies the user of information regarding the selling price and the shop.

According to another example aspect of the present invention, provided is a purchase support terminal configured to be able to communicate with a purchase support apparatus including a price determination unit that compares a requested purchase price of a registered article with a selling price at a shop of the article and determines whether or not the selling price is lower than or equal to the requested purchase price and a notification unit that, when it is determined by the price determination unit that the selling price is lower than or equal to the requested purchase price, performs notification of information regarding the selling price and the shop, and the purchase support terminal includes: a registration unit that registers the requested purchase price of the article that a user wishes to purchase; and a display processing unit that causes a display unit to display the information regarding the selling price and the shop notified by the notification unit.

According to yet another example aspect of the present invention, provided is a purchase support system including: a registration unit that registers a requested purchase price of an article that a user wishes to purchase; a price determination unit that compares the requested purchase price of the article registered by the registration unit with a selling price at a shop of the article and determines whether or not the selling price is lower than or equal to the requested purchase price; and a notification unit that, when it is determined by the price determination unit that the selling price is lower than or equal to the requested purchase price, notifies the user of information regarding the selling price and the shop.

According to yet another example aspect of the present invention, provided is a method including: comparing a requested purchase price of an article registered by a user with a selling price at a shop of the article and determining whether or not the selling price is lower than or equal to the requested purchase price; and when it is determined that the selling price is lower than or equal to the requested purchase price, notifying the user of information regarding the selling price and the shop.

According to yet another aspect of the present invention, provided is a method in a purchase support terminal configured to be able to communicate with a purchase support apparatus including a price determination unit that compares a requested purchase price of a registered article with a selling price at a shop of the article and determines whether or not the selling price is lower than or equal to the requested purchase price and a notification unit that, when it is determined by the price determination unit that the selling price is lower than or equal to the requested purchase price, performs notification of information regarding the selling price and the shop, and the method includes: registering the requested purchase price of the article that a user wishes to purchase; and causing a display unit to display the information regarding the selling price and the shop notified by the notification unit.

According to yet another aspect of the present invention, provided is a storage medium storing a program that causes a computer to perform: comparing a requested purchase price of an article registered by a user with a selling price at a shop of the article and determining whether or not the selling price is lower than or equal to the requested purchase price; and when it is determined that the selling price is lower than or equal to the requested purchase price, notifying the user of information regarding the selling price and the shop.

According to yet another aspect of the present invention, provided is a storage medium storing a program that causes a computer to perform a method in a purchase support terminal configured to be able to communicate with a purchase support apparatus including a price determination unit that compares a requested purchase price of a registered article with a selling price at a shop of the article and determines whether or not the selling price is lower than or equal to the requested purchase price and a notification unit that, when it is determined by the price determination unit that the selling price is lower than or equal to the requested purchase price, performs notification of information regarding the selling price and the shop, and the program causes the computer to perform: registering the requested purchase price of the article that a user wishes to purchase; and causing a display unit to display the information regarding the selling price and the shop notified by the notification unit.

### Advantageous Effects of Invention

According to the present invention, a user can make a purchase at a timing when wishing to make a purchase.

### BRIEF DESCRIPTION OF DRAWINGS

FIG. 1 is a schematic diagram illustrating the overall configuration of a purchase support system according to a first example embodiment of the present invention.

FIG. 2 is a block diagram illustrating a configuration of a purchase support terminal according to the first example embodiment of the present invention.

FIG. 3 is a block diagram illustrating a configuration of a shop apparatus according to the first example embodiment of the present invention.

FIG. 4 is a block diagram illustrating a configuration of a purchase support apparatus according to the first example embodiment of the present invention.

FIG. 5 is a sequence diagram illustrating a process in the purchase support system according to the first example embodiment of the present invention.

FIG. 6 is a schematic diagram illustrating one example of a purchase request entry screen on the purchase support terminal according to the first example embodiment of the present invention.

FIG. 7 is a schematic diagram illustrating one example of a purchase request information database stored in the purchase support apparatus according to the first example embodiment of the present invention.

FIG. 8 is a schematic diagram illustrating one example of an article information database stored in the purchase support apparatus according to the first example embodiment of the present invention.

FIG. 9 is a flowchart illustrating a process in the purchase support apparatus according to the first example embodiment of the present invention.

FIG. 10 is a flowchart illustrating a process in the purchase support terminal according to the first example embodiment of the present invention.

FIG. 11 is a schematic diagram illustrating one example of a screen that displays a purchase support notification in the purchase support terminal according to the first example embodiment of the present invention.

FIG. 12 is a schematic diagram illustrating another example of a screen that displays a purchase support notification in the purchase support terminal according to the first example embodiment of the present invention.

FIG. 13 is a block diagram illustrating a configuration of a stock management apparatus according to a second example embodiment of the present invention.

FIG. 14 is a flowchart illustrating a process in the stock management apparatus according to the second example embodiment of the present invention.

FIG. 15 is a flowchart illustrating a process in a purchase support terminal according to the second example embodiment of the present invention.

FIG. 16 is a flowchart illustrating a process in the purchase support apparatus according to the second example embodiment of the present invention.

FIG. 17 is a block diagram illustrating a configuration of a purchase support terminal according to a third example embodiment of the present invention.

FIG. 18 is a block diagram illustrating a configuration of a shop apparatus according to the third example embodiment of the present invention.

FIG. 19 is a block diagram illustrating a configuration of a purchase support apparatus according to the third example embodiment of the present invention.

FIG. 20 is a sequence diagram illustrating a process in a purchase support system according to the third example embodiment of the present invention.

FIG. 21 is a schematic diagram illustrating one example of a screen that displays calendar display in the purchase support terminal according to the third example embodiment of the present invention.

FIG. 22 is a block diagram illustrating a configuration of a purchase support terminal according to a fourth example embodiment of the present invention.

FIG. 23 is a block diagram illustrating a configuration of a shop apparatus according to the fourth example embodiment of the present invention.

FIG. 24 is a sequence diagram illustrating a process in a purchase support system according to the fourth example embodiment of the present invention.

FIG. 25 is a block diagram illustrating a configuration of a purchase support apparatus according to a fifth example embodiment of the present invention.

FIG. 26 is a sequence diagram illustrating a process in a purchase support system according to the fifth example embodiment of the present invention.

FIG. 27 is a schematic diagram illustrating an example of a computer apparatus according to a sixth example embodiment of the present invention.

FIG. 28 is a block diagram illustrating a function configuration of a purchase support apparatus according to another example embodiment of the present invention.

FIG. 29 is a block diagram illustrating a function configuration of a purchase support terminal according to another example embodiment of the present invention.

FIG. 30 is a block diagram illustrating a function configuration of a purchase support system according to another example embodiment of the present invention.

### DESCRIPTION OF EMBODIMENTS

### First Example Embodiment

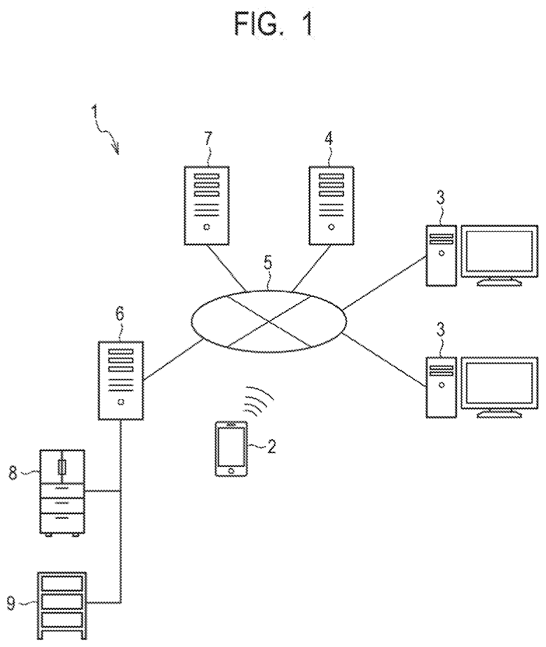

The purchase support system according to the first example embodiment of the present invention will be described with respect to FIG. 1 to FIG. 12.

First, the overall configuration of the purchase support system according to the present example embodiment will be described with reference to FIG. 1. FIG. 1 is a schematic diagram illustrating the overall configuration of a purchase support system according to the present example embodiment.

As illustrated in FIG. 1, a purchase support system 1 according to the present example embodiment provides a purchase support service that supports purchase of an article made by a user using a purchase support terminal 2 and includes the purchase support terminal 2, shop apparatuses 3, and a purchase support apparatus 4. The purchase support apparatus 4, the purchase support terminal 2, and the shop apparatuses 3 are connected to a network 5, respectively. The network 5 is the Internet, a cellular network, a Wide Area Network (WAN), a Local Area Network (LAN), or the like, for example, or may be formed of a combination thereof.

Furthermore, a stock management apparatus 6 and an information providing apparatus 7 are connected to the network 5. The stock management apparatus 6 manages stocks of an article in a residence of a user. The stock management apparatus 6 will be described in the second example embodiment. Further, the information providing apparatus 7 provides information that may affect an article price, which is an information providing server such as a news providing server that provides news, a weather information providing server that provides weather information, or the like, for example. The information providing apparatus 7 will be described in the fifth example embodiment.

The purchase support terminal 2 and the purchase support apparatus 4 are configured to be able to communicate with each other via the network 5. Further, the shop apparatuses 3 and the purchase support apparatus 4 are configured to be able to communicate with each other via the network 5. Further, the purchase support terminal 2 and the stock management apparatus 6 may be configured to be able to communicate with each other via the network 5, as illustrated in the second example embodiment. Further, the purchase support terminal 2 and the shop apparatuses 3 may be configured to be able to communicate with each other via the network 5, as illustrated in the third example embodiment. Further, the purchase support apparatus 4 and the information providing apparatus 7 may be configured to be able to communicate with each other via the network 5, as illustrated in the fifth example embodiment.

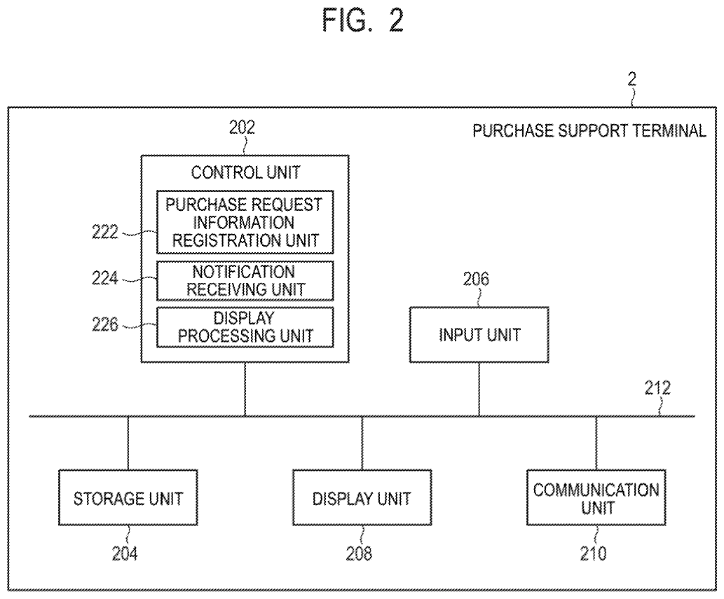

The configuration of the purchase support terminal 2, the shop apparatus 3, and the purchase support apparatus 4 in the purchase support system 1 according to the present example embodiment will be further described below with reference to FIG. 2 to FIG. 4.

First, the configuration of the purchase support terminal 2 according to the present example embodiment will be described with reference to FIG. 2. FIG. 2 is a block diagram illustrating the configuration of the purchase support terminal 2 according to the present example embodiment.

The purchase support terminal 2 is a user terminal used by a user who is provided with a purchase support service by the purchase support system 1 according to the present example embodiment. The user of the purchase support terminal 2 is a person who may be a customer of a shop that purchases an article at the shop where the shop apparatus 3 is installed accordingly. The purchase support terminal 2 is not particularly limited but is preferably an information processing terminal that can be carried by the user, which may be, for example, a smartphone, a tablet personal computer, a mobile phone, a personal digital assistant (PDA), a portable game device, or the like. Further, the purchase support terminal 2 may be a computer apparatus such as a laptop or desktop personal computer, for example. Further, the purchase support terminal 2 may be a networked home appliance such as a television receiver, a refrigerator, or the like having a communication function connectable to a network.

As illustrated in FIG. 2, the purchase support terminal 2 has a control unit 202, a storage unit 204, an input unit 206, a display unit 208, and a communication unit 210. The control unit 202, the storage unit 204, the input unit 206, the display unit 208, and the communication unit 210 are connected to a common bus 212, respectively.

The control unit 202 controls the operation of each unit of the purchase support terminal 2. The control unit 202 is formed of a central processing unit (CPU) that executes various programs, a read only memory (ROM) that stores various programs or data, a random access memory (RAM) to which various programs or data are expanded, a real time clock (RTC) that measures the current date and time, or the like. The control unit 202 has a purchase request information registration unit 222, a notification receiving unit 224, and a display processing unit 226 as function units implemented when the CPU executes a program.

The purchase request information registration unit 222 functions as a registration unit and transmits purchase request information on an article that the user wishes to purchase to the purchase support apparatus 4 via the network 5 by using the communication unit 210 and registers the purchase request information. The purchase request information is input to the purchase support terminal 2 by the user via the input unit 206. The purchase request information includes a name of an article that the user wishes to purchase and a requested purchase price, a purchase cycle, a previous purchase time, and a name of a requested purchase shop for the article, as described later. An article that may be registered is not particularly limited but may be, for example, an article periodically or regularly purchased by the user at a predetermined purchase cycle, more specifically, articles of food, articles of daily use, or the like, for example.

The notification receiving unit 224 receives a purchase support notification via the communication unit 210. The purchase support notification is a notification related to purchase support information notified via the network 5 from the purchase support apparatus 4 described later.

The display processing unit 226 causes the display unit 208 to display purchase support information included in a purchase support notification received from the notification receiving unit 224. The display processing unit 226 can cause the display unit 208 to display purchase support information in various schemes such as banner display, dialog display, display in a notification area, display in a lock screen, or the like, for example. Further, the display processing unit 226 can cause the display unit 208 to display a map and display purchase support information together with location information of a shop on the map.

The storage unit 204 is formed of a nonvolatile storage device such as flash memory, a hard disk drive, or the like, for example. The storage unit 204 is used to store various programs or data.

The input unit 206 is formed of an input device such as a touchscreen, a keyboard, a mouse, or the like, for example. The input unit 206 accepts operation input from the user and inputs an input signal to the purchase support terminal 2.

The display unit 208 is formed of a display device such as a liquid crystal display, an organic light emitting diode (OLED) display, or the like, for example. The display unit 208 displays various information under the control of the control unit 202. The display unit 208 can be formed as a touchscreen integrally with the input unit 206.

The communication unit 210 establishes connection to the network 5 to perform communication via the network 5 and transmits and receives data to and from the purchase support apparatus 4 or the like. The communication standard, the scheme, or the like of the communication unit 210 is not particularly limited and may be of a wireless scheme or a wired scheme.

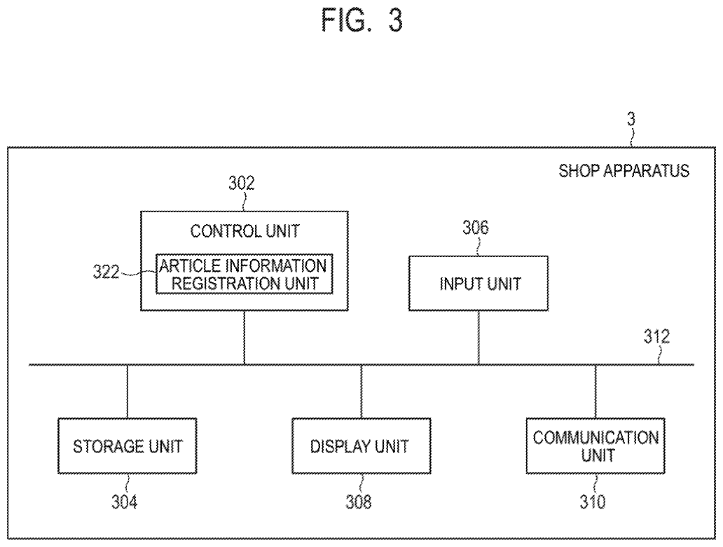

Next, the shop apparatus 3 according to the present example embodiment will be described with reference to FIG. 3. FIG. 3 is a block diagram illustrating a configuration of the shop apparatus 3 according to the present example embodiment.

The shop apparatus 3 is an information processing apparatus used by a shop proprietor that runs shops participating in a purchase support service provided by the purchase support system 1. Each of the shop apparatuses 3 is installed and managed inside the shop or inside a management facility that manages the shop in association with each of a plurality of shops participating in the purchase support service.

As illustrated in FIG. 3, the shop apparatus 3 has a control unit 302, a storage unit 304, an input unit 306, a display unit 308, and a communication unit 310. The control unit 302, the storage unit 304, the input unit 306, the display unit 308, and the communication unit 310 are connected to a common bus 312, respectively.

The control unit 302 controls each unit of the shop apparatus 3. The control unit 302 is formed of a CPU that executes various programs, a ROM that stores various programs or data, a RAM to which various programs or data are expanded, an RTC that measures the current date and time, or the like. The control unit 302 has an article information registration unit 322 as a function unit implemented when the CPU executes a program.

The article information registration unit 322 functions as a registration unit and transmits and registers article information, which is information related to an article sold in a corresponding shop, to the purchase support apparatus 4 via the network 5 by using the communication unit 310. Article information is input to the shop apparatus 3 by a shop proprietor via the input unit 306. The article information includes a type of an article sold in a shop and a selling price at the shop of the article, as described later. The selling price of an article is a daily selling price, for example, and may be a selling price in a particular time range when a selling price such as a limited-time sale is used.

The storage unit 304 is formed of a nonvolatile storage device such as a hard disk drive, flash memory, or the like, for example. The storage unit 304 is used to store various programs or data.

The input unit 306 is formed of an input device such as a touchscreen, a keyboard, a mouse, or the like, for example. The input unit 306 accepts operation input from the shop proprietor and inputs an input signal to the shop apparatus 3.

The display unit 308 is formed of a display device such as a liquid crystal display, an OLED display, or the like, for example. The display unit 308 displays various information under the control of the control unit 302. The display unit 308 can be formed as a touchscreen integrally with the input unit 306.

The communication unit 310 establishes connection to the network 5 to perform communication via the network 5 and transmits and receives data to and from the purchase support apparatus 4 or the like. The communication standard, the scheme, or the like of the communication unit 310 is not particularly limited and may be of a wireless scheme or a wired scheme.

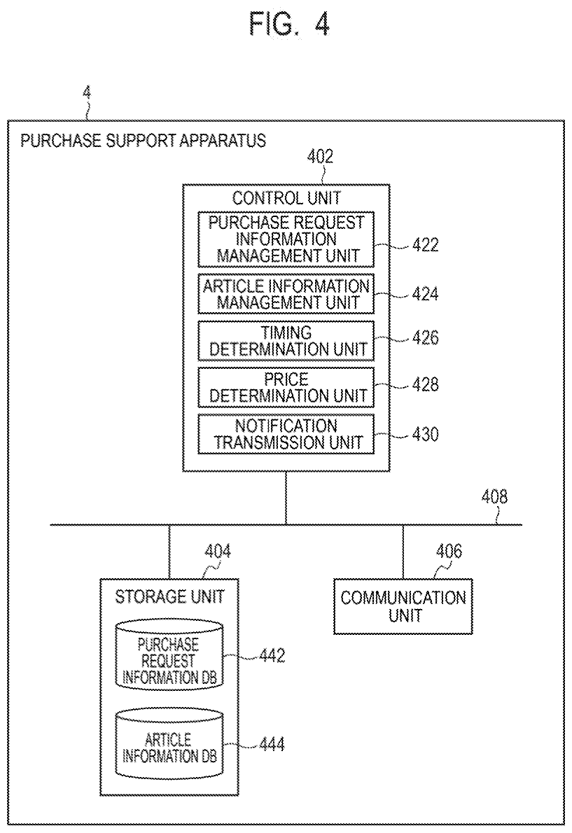

Next, the configuration of the purchase support apparatus 4 according to the present example embodiment will be described with reference to FIG. 4. FIG. 4 is a block diagram illustrating a configuration of the purchase support apparatus 4 according to the present example embodiment.

The purchase support apparatus 4 is a purchase support server that provides a purchase support service to the user who uses the purchase support terminal 2. The purchase support apparatus 4 is installed and managed by a service provider such as a proprietor that provides the purchase support service.

As illustrated in FIG. 4, the purchase support apparatus 4 has a control unit 402, a storage unit 404, and a communication unit 406. The control unit 402, the storage unit 404, and the communication unit 406 are connected via a common bus 408, respectively.

The control unit 402 controls the operation of each unit of the purchase support apparatus 4. The control unit 402 is formed of a CPU that executes various programs, a ROM that stores various programs or data, a RAM to which various programs or data are expanded, an RTC that measures the current date and time, or the like. The control unit 402 has a purchase request information management unit 422, an article information management unit 424, a timing determination unit 426, a price determination unit 428, and a notification transmission unit 430 as a function unit implemented when the CPU executes a program.

The purchase request information management unit 422 functions as a management unit and manages purchase request information transmitted from the purchase support terminal 2 to the purchase support apparatus 4 as described above. The purchase request information management unit 422 registers and manages purchase request information in a purchase request information database (DB) 442 stored in the storage unit 404.

The article information management unit 424 functions as a management unit and manages article information transmitted from the shop apparatus 3 to the purchase support apparatus 4 as described above. The article information management unit 424 stores, registers, and manages article information in an article information DB 444 stored in the storage unit 404.

The timing determination unit 426 functions as a determination unit and references the purchase request information DB 442 to perform timing determination to determine whether or not it is time to make a purchase for an article registered in the purchase request information DB 442. Specifically, the timing determination unit 426 determines whether or not an elapsing ratio, which is a ratio of an elapsing period from the previous purchase time to a purchase cycle, is greater than or equal to a predetermined threshold for an article registered in the purchase request information DB 442. The timing determination unit 426 decides that an article for which the elapsing ratio is determined to be greater than or equal to the predetermined threshold is an article that it is time to purchase and sets the article as a target article that is a target of price determination performed by the price determination unit 428. The threshold for the elapsing ratio can be set as appropriate and may be set to a value greater than or equal to ½, for example.

The price determination unit 428 functions as a determination unit and performs price determination for a target article set as a target of price determination by the timing determination unit 426. In price determination, first, the price determination unit 428 extracts, from the article information DB 444, a selling price which is provided for a shop of the same article as the target article and registered for a requested purchase shop. Subsequently, the price determination unit 428 compares a requested purchase price of the target article with the extracted selling price and determines whether or not the selling price is lower than or equal to the requested purchase price. That is, the price determination unit 428 compares a requested purchase price of a target article with the selling price at a shop of the target article and determines whether or not the selling price is lower than or equal to the requested purchase price. When a plurality of selling prices are extracted, the same determination is performed for each of the extracted selling prices. When determining that the selling price is lower than or equal to the requested purchase price, the price determination unit 428 instructs the notification transmission unit 430 to transmit a purchase support notification to the purchase support terminal 2.

The notification transmission unit 430 functions as a notification unit and, in response to receiving a transmission instruction of a purchase support notification from the price determination unit 428, transmits a purchase support notification including purchase support information to the purchase support terminal 2 via the network 5 in push notification by using the communication unit 406. Thereby, the notification transmission unit 430 notifies the user of the purchase support information. The purchase support information includes a selling price that is lower than or equal to a requested purchase price of a target article and shop information that is information on a shop which sells the same article as the target article at the selling price. The shop information may include information used for identifying a shop such as the location address of the shop, the telephone number of the shop, the website address of the shop, or the like and information associated with the shop in addition to the name of the shop. Note that, when a plurality of selling prices that are lower than or equal to a requested purchase price are present, only the lowest selling price out of these selling prices and the shop information thereon may be included in the purchase support information, or a plurality of selling prices and respective pieces of shop information may be included in the purchase support information even when there is a price difference.

The storage unit 404 is formed of a nonvolatile storage device such as a hard disk drive, flash memory, or the like, for example. The storage unit 404 is used to store various programs or data. The storage unit 404 stores the purchase request information DB 442 and the article information DB 444.

In the purchase request information DB 442, purchase request information managed by the purchase request information management unit 422 is registered as described above. In the article information DB 444, article information managed by the article information management unit 424 is registered as described above.

The communication unit 406 establishes connection to the network 5 to perform communication via the network 5 and transmits and receives data to and from the purchase support terminal 2, the shop apparatus 3, or the like. The communication standard, the scheme, or the like of the communication unit 406 is not particularly limited and may be of a wired scheme or a wireless scheme.

The purchase support system 1 according to the present example embodiment is configured as discussed above. In the purchase support system 1, the purchase support apparatus 4 provides purchase support information to the user who uses the purchase support terminal 2 and supports purchase of an article made by the user. That is, when the elapsing ratio for a purchase requesting article of the user registered in the purchase request information DB 442 becomes a predetermined threshold or greater, the purchase support apparatus 4 compares a requested purchase price of the article with a selling price at a shop of the same article registered in the article information DB 444. Thereby, the purchase support apparatus 4 determines whether or not a selling price that is lower than or equal to the requested purchase price is present and, if the selling price that is lower than or equal to the requested purchase price is present, transmits purchase support information including the selling price and the shop information thereon to the purchase support terminal 2 of the user for notification. Therefore, according to the present example embodiment, the user can purchase an article at more suitable timing at a lower price.

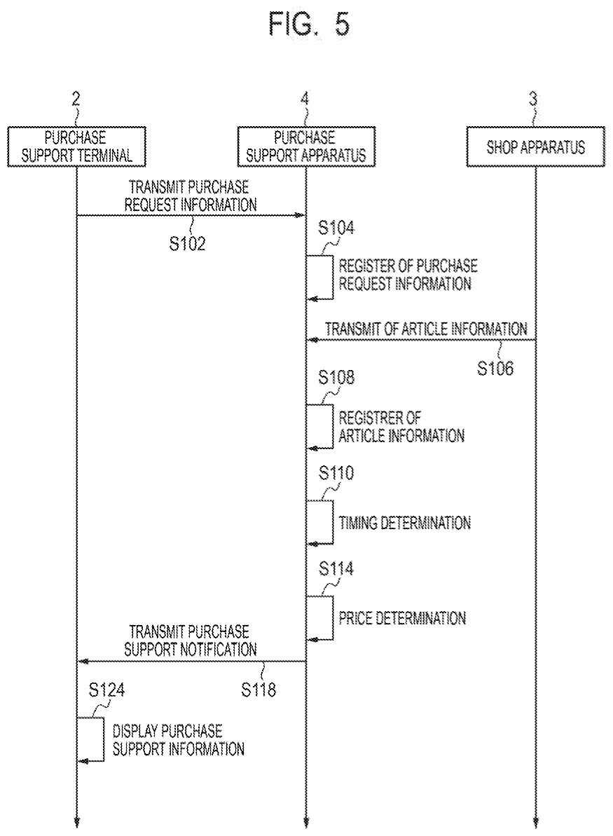

Next, the process in the purchase support system 1 according to the present example embodiment will be further described with reference to FIG. 5 to FIG. 12. FIG. 5 is a sequence diagram illustrating the process in the purchase support system 1 according to the present example embodiment.

Purchase request information on an article is input to the purchase support terminal 2 via the input unit 206 by the user. As illustrated in FIG. 5, the purchase request information registration unit 222 of the purchase support terminal 2 transmits the purchase request information input by the user to the purchase support apparatus 4 via the network 5 (step S102).

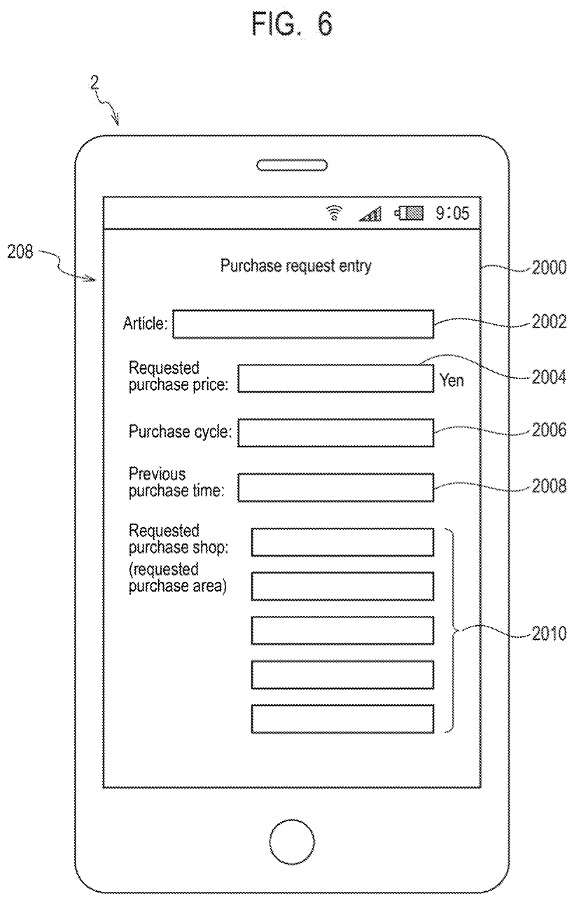

FIG. 6 is a schematic diagram illustrating one example of a purchase request entry screen in the purchase support terminal 2 according to the present example embodiment. As illustrated in FIG. 6, a purchase request entry screen 2000 is displayed on the display unit 208 of the purchase support terminal 2. The purchase request entry screen 2000 has an article entry field 2002, a requested purchase price entry field 2004, a purchase cycle entry field 2006, a previous purchase time entry field 2008, and requested purchase shop entry fields 2010.

The article entry field 2002 is a field to which the user inputs a name of a purchase requesting article that is an article that the user wishes to purchase and other information used for identifying the article. For example, the user may input, to the article entry field 2002, a name of an article such as “eggs”, “milk”, or the like without identifying a specific item name or may input a specific item name. Further, the user may input a requested purchase quantity such as the number of articles, the amount of article, or the like to the article entry field 2002.

The requested purchase price entry field 2004 is a field to which the user inputs a requested purchase price of a purchase requesting article. The requested purchase price is the upper limit price of a price of the article at which the user may purchase the article.

The purchase cycle entry field 2006 is a field to which the user inputs a purchase cycle of the purchase requesting article. The user may input, to the purchase cycle entry field 2006, for example, a purchase frequency such as “once a month” when the purchase cycle corresponds to a monthly basis, “once a week” when the purchase cycle corresponds to a weekly basis, or the like. Further, the purchase cycle entry field 2006 may be configured so that the user selects and inputs a predetermined purchase cycle by using a pulldown list or the like, for example.

The previous purchase time entry field 2008 is a field to which the user inputs the time when the user previously purchased the purchase requesting article. For example, the user may input a specific date of the previous purchase to the previous purchase time entry field 2008 as the time of the previous purchase of the purchase requesting article made by the user. Further, the user may input an ascending period from the current time to the previous time of purchase made by the user in a form of the number of days, the number of weeks, or the number of months, such as “10 days ago”, “two weeks ago”, “two months ago”, or the like in the previous purchase time entry field 2008 to identify the previous purchase time, for example.

Each of the requested purchase shop entry fields 2010 is a field to which the user inputs a name of a requested purchase shop, which is a shop where the user wishes to purchase a purchase requesting article, and other information used for identifying the shop. A plurality of requested purchase shop entry fields 2010 are provided, and names of the plurality of requested purchase shops can be input. Note that the requested purchase shop may be identified by various information related to the shop in addition to the name thereof. For example, the user may also input an address as a requested purchase area where the user wishes to purchase a purchase requesting article in the requested purchase shop entry field 2010. In such a case, one or a plurality of shops included within the address are automatically input as requested purchase shops. Further, the requested purchase area may also be designated as an area on a map displayed on the display unit 208 of the purchase support terminal 2.

In such a way, the user may input purchase request information including a name of an article that the user wishes to purchase, a requested purchase price, a purchase cycle, the previous purchase time, and one or more names of requested purchase shops via the entry screen 2000 of the purchase support terminal 2.

In the purchase support apparatus 4 to which purchase request information is transmitted from the purchase support terminal 2, the purchase request information management unit 422 registers the transmitted purchase request information in the purchase request information DB 442 (step S104). Thereby, the purchase request information management unit 422 updates the purchase request information DB 442.

The registration of purchase request information in the purchase support apparatus 4 is performed in such a way. The registration of purchase request information is repeatedly performed as appropriate at any timing in accordance with the user's needs.

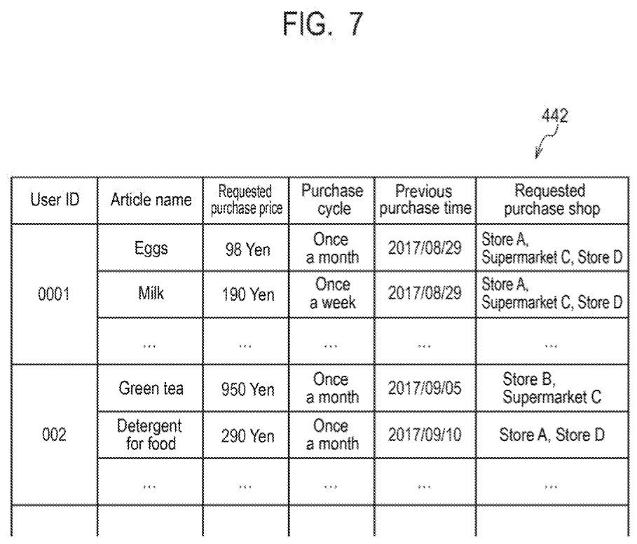

FIG. 7 is a schematic diagram illustrating one example of the purchase request information DB 442 stored in the purchase support apparatus 4 according to the present example embodiment. In the purchase request information DB 442, purchase request information including the name of articles, the requested purchase price, the purchase cycle, the previous purchase time, and the requested purchase shop is registered for respective user identifications (ID) used for identifying a plurality of users, as illustrated in FIG. 7. One or multiple pieces of purchase request information can be registered on a user ID basis.

On the other hand, article information is input to the shop apparatus 3 via the input unit 306 by a shop proprietor. The article information registration unit 322 of the shop apparatus 3 transmits article information input by the shop proprietor to the purchase support apparatus 4 via the network 5 (step S106). The article information includes names of articles to be sold in a shop and selling prices at the shop of the articles.

In the purchase support apparatus 4 to which the article information has been transmitted from the shop apparatus 3, the article information management unit 424 registers the transmitted article information in the article information DB 444 (step S108). Thereby, the article information management unit 424 updates the article information DB 444.

The registration of article information in the purchase support apparatus 4 is performed in such a way. The registration of article information is repeatedly performed as appropriate at any timing in accordance with the shop proprietor's needs.

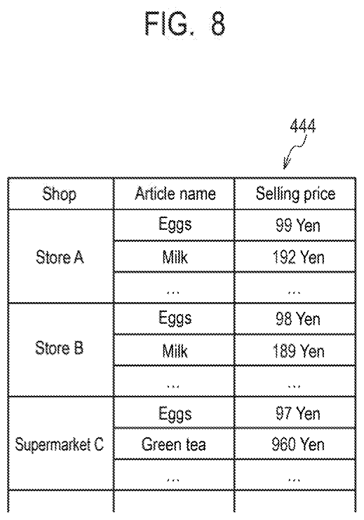

FIG. 8 is a schematic diagram illustrating one example of the article information DB 444 stored in the purchase support apparatus 4 according to the present example embodiment. In the article information DB 444, article information including the name of articles to be sold in a shop and selling prices at the shop of the articles is registered for each shop, as illustrated in FIG. 8. One or multiple pieces of article information can be registered on a shop basis in accordance with the number of sales items thereof.

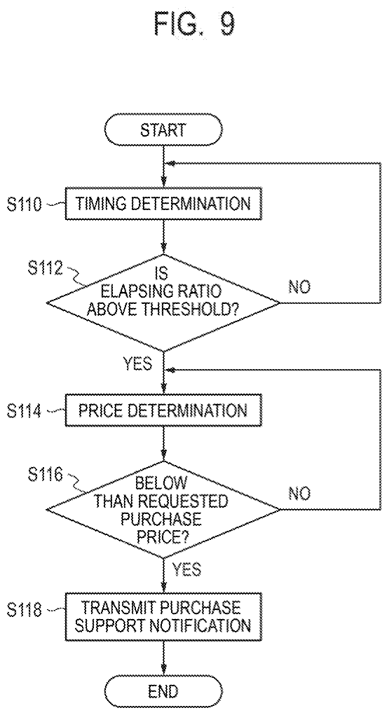

In the purchase support apparatus 4, purchase request information is registered in the purchase request information DB 442, and the article information is registered in the article information DB 444, as described above. In the purchase support apparatus 4 having the purchase request information DB 442 and the article information DB 444 as described above, timing determination (step S1101, price determination (step S114), and transmission of purchase support information (step S118) are sequentially performed. The process in the purchase support apparatus 4 including these processes will be described below with reference to FIG. 9. FIG. 9 is a flowchart illustrating the process in the purchase support apparatus 4 according to the present example embodiment.

First, the timing determination unit 426 of the purchase support apparatus 4 references the purchase request information DB 442. The timing determination unit 426 determines Whether or not the elapsing ratio, which is the ratio of the elapsing period from the previous purchase time to the purchase cycle, is greater than or equal to a predetermined threshold for an article registered in the referenced purchase request information DB 442. Thereby, the timing determination unit 426 performs timing determination to determine whether or not it is time to purchase the article (step S110). As discussed above, in the present example embodiment, the user determines whether or not it is time to make a purchase based on the elapsing ratio and thus is able to purchase a purchase requesting article at a more suitable timing.

If the elapsing ratio is greater than or equal to the predetermined threshold (step S112, YES), the timing determination unit 426 sets the article to a target article, which is a target of price determination performed by the price determination unit 428, as an article that it is time to purchase. On the other hand, If the elapsing ratio is less than the predetermined threshold (step S112, NO), the timing determination unit 426 repeatedly performs the timing determination (step S110) regularly or irregularly until the elapsing ratio becomes the predetermined threshold or greater.

Next, the price determination unit 428 of the purchase support apparatus 4 performs price determination for the target article set as the target of price determination by the timing determination unit 426 (step S114). In price determination, first, the price determination unit 428 extracts, from the article information DB 444, a selling price of the same article as the target article and registered for a requested purchase shop. Subsequently, the price determination unit 428 compares a requested purchase price of the target article with the extracted selling price and determines whether or not the selling price is lower than or equal to the requested purchase price. When a plurality of selling prices are extracted, the same determination is performed for each of the extracted selling prices. As discussed above, in the present example embodiment, the user determines whether or not the selling price that is lower than the requested purchase price is present and thus is able to purchase a purchase requesting article at a lower price.

If the selling price is lower than or equal to the requested purchase price (step S116, YES), the price determination unit 428 instructs the notification transmission unit 430 to transmit a purchase support notification to the purchase support terminal 2. On the other hand, if the selling price is higher than the requested purchase price (step S116, NO), the price determination unit 428 repeatedly performs the price determination (step S114) regularly or irregularly until the selling price becomes the requested purchase price or lower.

Next, in response to receiving instruction of notification from the price determination unit 428, the notification transmission unit 430 of the purchase support apparatus 4 transmits a purchase support notification including purchase support information to the purchase support terminal 2 via the network 5 in push notification (step S118). The purchase support information includes a selling price that is lower than or equal to a requested purchase price of the target article and shop information that is information on a shop which sells the same article as the target article at the selling price.

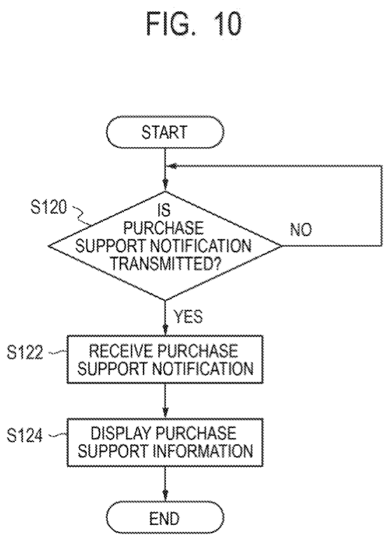

In such a way, the purchase support notification is transmitted from the purchase support apparatus 4 to the purchase support terminal 2. In the purchase support terminal 2 to which the purchase support notification has been transmitted, display of the purchase support information included in the purchase support notification (step S124) is performed. When the purchase support information is displayed on the purchase support terminal 2, the user is informed of the purchase support information. The process in the purchase support terminal 2 including this process will be described below with reference to FIG. 10. FIG. 10 is a flowchart illustrating the process in the purchase support terminal 2 according to the present example embodiment.

If a purchase support notification is transmitted from the purchase support apparatus 4 to the purchase support terminal 2 (step S120, YES), the notification receiving unit 224 of the purchase support terminal 2 receives the transmitted purchase support notification (step S122). On the other hand, if no purchase support notification is transmitted (step S120, NO), the notification receiving unit 224 waits for transmission of a purchase support notification.

Next, the display processing unit 226 of the purchase support terminal 2 causes the display unit 208 to display the purchase support information included in the purchase support notification received by the notification receiving unit 224 (step S124). The display processing unit 226 can cause the display unit 208 to display the purchase support information in various schemes such as banner display, dialog display, display in a notification area, display in a lock screen, or the like, for example.

The user may consider whether or not to purchase an item indicated with the purchase support information based on the purchase support information displayed on the purchase support terminal 2.

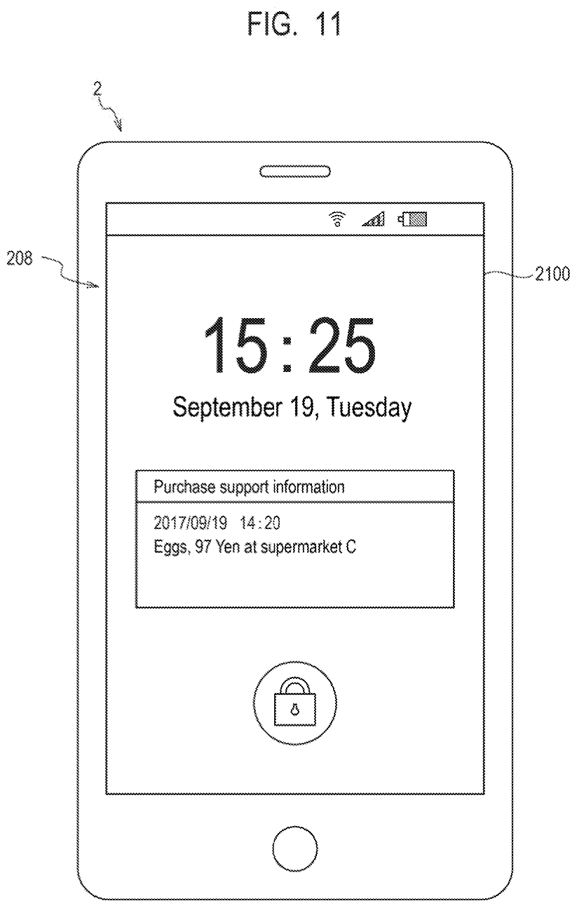

FIG. 11 is a schematic diagram illustrating one example of a screen that displays a purchase support information in the purchase support terminal 2 according to the present example embodiment. As illustrated in FIG. 11, the display processing unit 226 can display purchase support information including the selling price of a purchase requesting article and the shop information thereon on a lock screen 2100 displayed on the display unit 208.

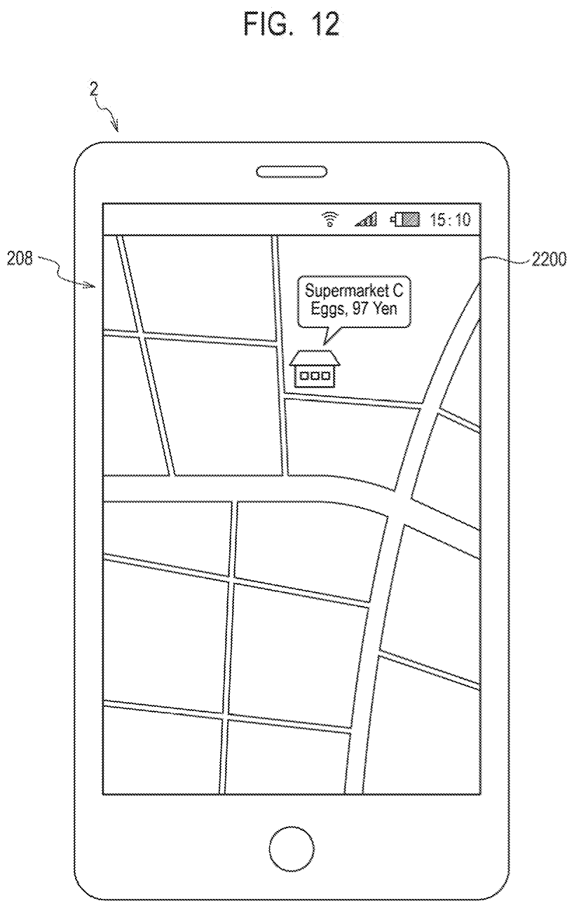

Further, FIG. 12 is a schematic diagram illustrating another example of a screen that displays a purchase support information in the purchase support terminal 2 according to the present example embodiment. As illustrated in FIG. 12, the display processing unit 226 can display a map screen 2200 indicating a map on the display unit 208 and display, on the map screen 2200, purchase support information including the selling price of a purchase requesting article and the shop information thereon. In such a case, the display processing unit 226 causes purchase support information to be displayed on the map together with an icon indicating the location information on the shop, for example. Since the user can confirm the location of the shop on the map, this enables the user to determine whether or not to actually purchase the purchase requesting article at the shop in accordance with the location of the shop and confirm the path to the shop on the map when determining to make a purchase.

As described above, according to the present example embodiment, timing determination is performed, and when the elapsing ratio becomes a predetermined threshold or greater for a purchase requesting article of the user registered in the purchase request information DB 442, price determination is performed. Accordingly, in the present example embodiment, it is determined whether or not a selling price that is lower than or equal to a requested purchase price is present, and if a selling price that is lower than or equal to the requested purchase price is present, purchase support information including the selling price and the shop information thereon is notified to the purchase support terminal 2 of the user. Therefore, according to the present example embodiment, the user can purchase an article at a lower price at a more suitable timing and purchase the article at a timing when the user wishes to make a purchase.

Note that, although a case where timing determination is performed by the timing determination unit 426 in the purchase support apparatus 4 has been described in the above, the example embodiment is not limited thereto. The timing determination performed by the timing determination unit 426 may not be performed. That is, it is possible to perform price determination by the price determination unit 428 without determining a timing to make a purchase. In such a case, it is not necessary to input a purchase cycle in registration of purchase request information, and even for an article where it is difficult to set a purchase cycle, such as an article which is purchased irregularly, an article which is purchased less frequently, or the like, it is possible to perform notification of purchase support information in the same manner as described above.

### Second Example Embodiment

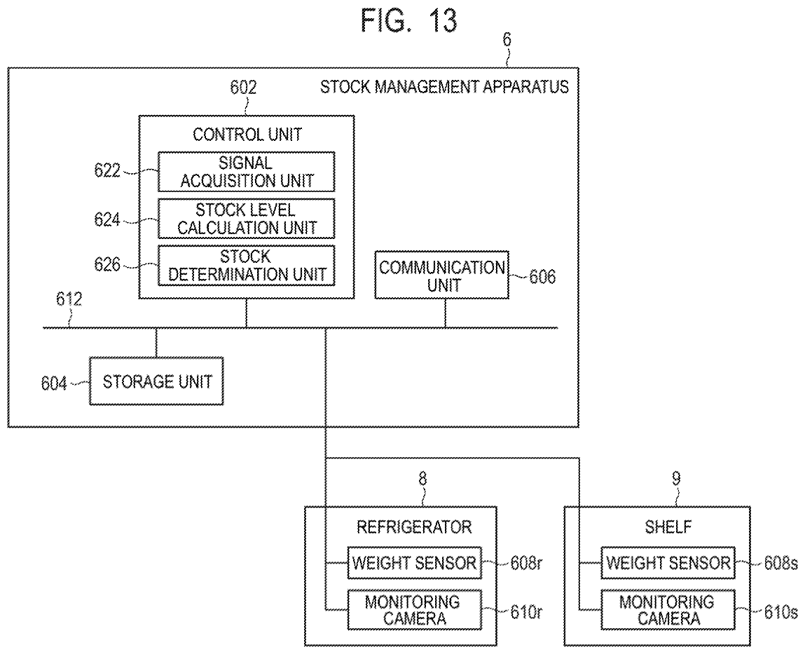

A purchase support system according to the second example embodiment of the present invention will be described with reference to FIG. 13 to FIG. 16. Note that the same components as those in the first example embodiment are labeled with the same references, and the description thereof will be omitted or simplified.

The basic configuration of the purchase support system according to the present example embodiment is substantially the same as the configuration of the purchase support system according to the first example embodiment. The purchase support system according to the present example embodiment is different from the purchase support system according to the first example embodiment in that stock management is performed by the stock management apparatus 6 and purchase support notification is performed also for a stock shortage article in addition.

The stock management apparatus 6 is installed for managing stocks of articles stored in a storage place such as a refrigerator 8, a shelf 9 (see FIG. 1), or the like, for example, in the residence of the user. Note that the storage place of an article where the stock thereof is managed by the stock management apparatus 6 is not limited to the refrigerator 8 and the shelf 9 but may be any storage place where the user stores an article, such as a storeroom, a storage, or the like, for example, other than the above. The configuration of the stock management apparatus 6 will be described below with reference to FIG. 13. FIG. 13 is a block diagram illustrating the configuration of the stock management apparatus 6 according to the present example embodiment.

As illustrated in FIG. 13, the stock management apparatus 6 has a control unit 602, a storage unit 604, and a communication unit 606. Further, the stock management apparatus 6 has a weight sensor 608r and a monitoring camera 610r installed in the refrigerator 8, respectively. Further, the stock management apparatus 6 has a weight sensor 608s and a monitoring camera 610s installed in the shelf 9, respectively. The control unit 602, the storage unit 604, the communication unit 606, the weight sensors 608r and 608s, and the monitoring cameras 610r and 610s are connected to a common bus 612, respectively. Note that the weight sensors 608r and 608s and the monitoring cameras 610r and 610s may be communicably connected to the stock management apparatus 6 via a network.

The weight sensor 608r installed in the refrigerator 8 determines the weight of the stock of a particular article stored in the refrigerator 8 and outputs a weight signal that is a signal in accordance with the weight. The weight sensor 608r can output a weight signal regularly or at real time. Further, the monitoring camera 610r installed in the refrigerator 8 captures an image of a particular article stored in the refrigerator 8 and outputs an image signal in accordance with the captured image. The monitoring camera 610r can output an image signal regularly or at real time. Note that only one of the weight sensor 608r and the monitoring camera 610r may be installed in the refrigerator 8.

The weight sensor 608s installed in the shelf 9 determines the weight of the stock of a particular article stored in the shelf 9 and outputs a weight signal that is a signal in accordance with the weight. The weight sensor 608s can output a weight signal regularly or at real time. Further, the monitoring camera 610s installed in the shelf 9 captures an image of a particular article stored in the shelf 9 and outputs an image signal in accordance with the captured image. The monitoring camera 610s can output an image signal regularly or at real time. Note that only one of the weight sensor 608s and the monitoring camera 610s may be installed in the shelf 9.

The control unit 602 controls the operation of each unit of the stock management apparatus 6. The control unit 602 is formed of a CPU that executes various programs, a ROM that stores various programs or data, a RAM to which various programs or data are expanded, an RTC that measures the current date and time, or the like. The control unit 602 has a signal acquisition unit 622, a stock level calculation unit 624, and a stock determination unit 626 as a function unit implemented when the CPU executes a program.

The signal acquisition unit 622 acquires, regularly or at real time, weight signals respectively output from the weight sensors 608r and 608s. Further, the signal acquisition unit 622 acquires, regularly or at real time, image signals respectively output from the monitoring cameras 610r and 610s. The weight signals and the image signals acquired by the signal acquisition unit 622 are used for calculation of the stock level performed by the stock level calculation unit 624, respectively.

The stock level calculation unit 624 functions as a calculation unit and calculates the stock level of a particular article stored in the refrigerator 8 based on a weight signal output from the weight sensor 608r installed in the refrigerator 8. Further, the stock level calculation unit 624 calculates the stock level of a particular article stored in the refrigerator 8 based on an image signal output from the monitoring camera 610r installed in the refrigerator 8. Further, stock level calculation unit 624 calculates the stock level of a particular article stored in the shelf 9 based on a weight signal output from the weight sensor 608s installed in the shelf 9. Further, the stock level calculation unit 624 calculates the stock level of a particular article stored in the shelf 9 based on an image signal output from the monitoring camera 610s installed in the shelf 9. In calculation of the stock level based on a weight signal, a change amount of the stock of an article is calculated based on a weight change, and the stock level can be calculated from the calculated change amount and the initial weight. Further, in calculation of the stock level based on an image signal, the stock level can be calculated by identifying the type and the number of articles by using an image recognition technology.

The stock determination unit 626 functions as a determination unit and determines whether or not the article is a stock shortage article based on the calculated stock level for each of the articles, the stock level of which is calculated by the stock level calculation unit 624. The stock determination unit 626 compares a stock level calculated for the article with a predetermined threshold set for the stock level of the article and, if the calculated stock level is less than or equal to the threshold, determines that the article is a stock shortage article. In such a way, in the stock management apparatus 6, a stock shortage article can be detected.

In response to determining that the article is a stock shortage article, the stock determination unit 626 transmits stock shortage article information, which is information regarding the stock shortage article, to the purchase support terminal 2 via the network 5 by using the communication unit 606. Note that the stock determination unit 626 may be configured to transmit stock shortage article information directly to the purchase support terminal 2 without via the network 5 by using the communication unit 606.

The storage unit 604 is formed of a nonvolatile storage device such as flash memory, a hard disk drive, or the like, for example. The storage unit 604 is used to store various programs or data.

The communication unit 606 establishes connection to the network 5 to perform communication via the network 5 and transmits and receives data to and from the purchase support terminal 2 or the like. The communication standard, the scheme, or the like of the communication unit 606 is not particularly limited and may be of a wireless scheme or a wired scheme. Note that the communication unit 606 may be configured to transmit and receive data directly to and from the purchase support terminal 2 without being connected to the network 5.

In the purchase support system according to the present example embodiment, it is possible not only to transmit a purchase support notification to the purchase support terminal 2 as in the same manner as in the first example embodiment but also to register a stock shortage article detected by the stock management apparatus 6 as a purchase requesting article and transmit a purchase support notification to the purchase support terminal 2. The processes for the above in the stock management apparatus 6, the purchase support terminal 2, and the purchase support apparatus 4 will be described below.

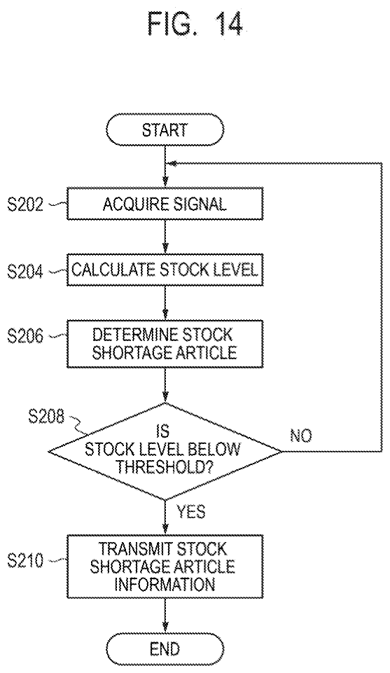

First, a process in the stock management apparatus 6 including detection of a stock shortage article will be described with reference to FIG. 14. FIG. 14 is a flowchart illustrating the process in the stock management apparatus 6 according to the present example embodiment.

First, the signal acquisition unit 622 of the stock management apparatus 6 acquires weight signals respectively output from the weight sensors 608r and 608s installed in the refrigerator 8 and the shelf 9, respectively. Further, the signal acquisition unit 622 acquires image signals respectively output from the monitoring cameras 610r and 610s installed in the refrigerator 8 and the shelf 9, respectively (step S202).

Next, the stock level calculation unit 624 of the stock management apparatus 6 calculates the stock level of articles stored in the refrigerator 8 and the shelf 9 based on the weight signals and the image signals acquired by the signal acquisition unit 622 (step S204). That is, the stock level calculation unit 624 calculates the stock level of a particular article stored in the refrigerator 8 based on a weight signal output from the weight sensor 608r installed in the refrigerator 8. Further, the stock level calculation unit 624 calculates the stock level of a particular article stored in the refrigerator 8 based on an image signal output from the monitoring camera 610r installed in the refrigerator 8. Further, the stock level calculation unit 624 calculates the stock level of a particular article stored in the shelf 9 based on a weight signal output from the weight sensor 608s installed in the shelf 9. Further, the stock level calculation unit 624 calculates the stock level of a particular article stored in the shelf 9 based on an image signal output from the monitoring camera 610s installed in the shelf 9.

Next, the stock determination unit 626 of the stock management apparatus 6 determines based on the calculated stock level whether or not the article is a stock shortage article for each of the articles, the stock level of which has been calculated by the stock level calculation unit 624 (step S206). In the determination of a stock shortage article, the stock determination unit 626 compares the stock level calculated for the article with a predetermined threshold set for the stock level of the article.

If the calculated stock level is less than or equal to the threshold (step S208, YES), the stock determination unit 626 determines that the article is a stock shortage article. On the other hand, if the calculated stock level is greater than the threshold (step S208, NO), the stock determination unit 626 repeatedly performs determination of a stock shortage article (step S206) regularly or irregularly.

In such a way, the stock management apparatus 6 detects a stock shortage article in the refrigerator 8 and the shelf 9 based on the output signals from the weight sensors 608r and 608s and the monitoring cameras 610r and 610s.

Next, if it is determined that the article is a stock shortage article, the stock determination unit 626 transmits stock shortage article information, which is information regarding the stock shortage article, to the purchase support terminal 2 (step S210).

In such a way, the stock management apparatus 6 detects a stock shortage article from articles stored in the refrigerator 8 and the shelf 9 and transmits the stock shortage article information to the purchase support terminal 2.

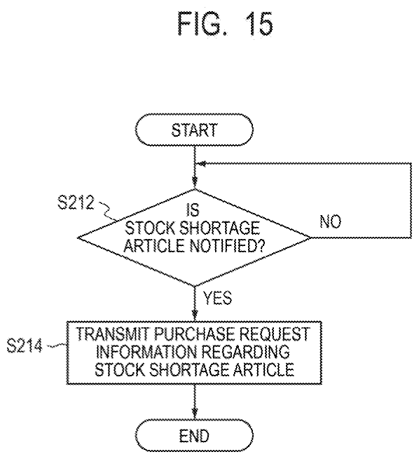

Next, the process in the purchase support terminal 2 to which the stock shortage article information has been transmitted will be described with reference to FIG. 15. FIG. 15 is a flowchart illustrating the process in the purchase support terminal 2 according to the present example embodiment.

The purchase request information registration unit 222 of the purchase support terminal 2 waits for transmission of stock shortage article information from the stock management apparatus 6 (step S212). In response to transmission of the stock shortage article information (step S212, YES), the purchase request information registration unit 222 handles the stock shortage article as an article that the user wishes to purchase and transmits purchase request information regarding the stock shortage article to the purchase support apparatus 4 (step S214). The purchase request information regarding a stock shortage article includes the name of the stock shortage article, the requested purchase price for the stock shortage article, and the name of requested purchase shop in the same manner as the purchase request information in the first example embodiment. However, the requested purchase price for the stock shortage article is not required to include a purchase cycle or a previous purchase time.

For the requested purchase price and the name of the requested purchase shop included in the purchase request information regarding a stock shortage article, information set by the user in advance can be used. Further, the purchase request information and the name of the requested purchase shop may be set by being input by the user via the input unit 206 in the same manner as in the first example embodiment.

In such a way, in response to transmission of the stock shortage article information from the stock management apparatus 6, the purchase support terminal 2 transmits the purchase request information regarding the stock shortage article to the purchase support apparatus 4.

Note that the purchase request information regarding a stock shortage article is not necessarily required to be transmitted from the purchase support terminal 2 to the purchase support apparatus 4. For example, the stock management apparatus 6 may be configured to detect a stock shortage article and transmit the purchase request information regarding the detected stock shortage article directly to the purchase support apparatus 4 via the network 5.

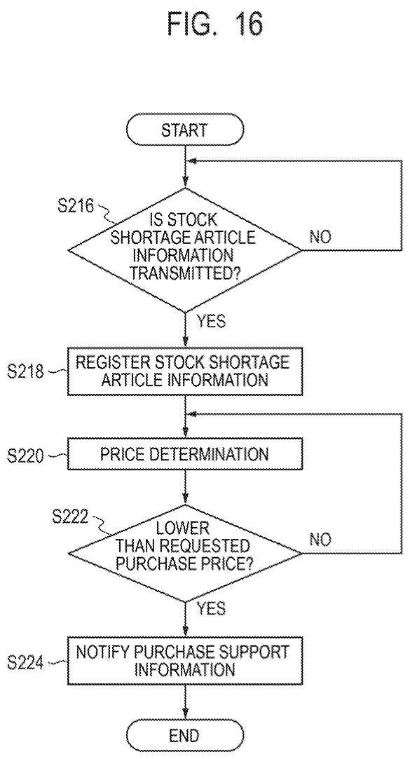

Next, the process in the purchase support apparatus 4 to which the purchase request information regarding the stock shortage article has been transmitted will be described with reference to FIG. 16. FIG. 16 is a flowchart illustrating the process in the purchase support apparatus 4 according to the present example embodiment.

The purchase request information management unit 422 of the purchase support apparatus 4 waits for transmission of purchase request information regarding a stock shortage article from the purchase support terminal 2 (step S216). In response to transmission of the purchase request information regarding the stock shortage article (step S216, YES), the purchase request information management unit 422 registers the purchase request information regarding the transmitted stock shortage article in the purchase request information DB 442 (step S218). Thereby, the purchase request information management unit 422 updates the purchase request information DB 442.

Next, the price determination unit 428 of the purchase support apparatus 4 performs price determination on the stock shortage article where purchase request information is registered in the purchase request information DB 442 (step S220). The price determination for the stock shortage article can be performed in the same manner as the price determination of step S114 in the first example embodiment. Note that, since the stock is short for a stock shortage article and it is already time to make a purchase, the timing determination prior to the price determination is not performed unlike the first example embodiment.

If the selling price is lower than or equal to the requested purchase price (step S222, YES), the price determination unit 428 instructs the notification transmission unit 430 to transmit a purchase support notification to the purchase support terminal 2. On the other hand, if the selling price is higher than the requested purchase price (step S222, NO), the price determination unit 428 repeatedly performs the price determination (step S220) regularly or irregularly until the selling price is less than or equal to the requested purchase price.

Next, in response to the instruction of notification from the price determination unit 428, the notification transmission unit 430 of the purchase support apparatus 4 transmits a purchase support notification including purchase support information to the purchase support terminal 2 via the network 5 in push notification (step S224). The purchase support information includes a selling price that is lower than or equal to a requested purchase price of the stock shortage article and shop information that is information on a shop which sells the same article as the stock shortage article at the selling price.

In such a way, the purchase support notification regarding the stock shortage article is transmitted from the purchase support apparatus 4 to the purchase support terminal 2. In the purchase support terminal 2 to which the purchase support notification regarding the stock shortage article has been transmitted, the purchase support information included in the purchase support notification is displayed in the same manner as in the first example embodiment.

As described above, in the present example embodiment, for a stock shortage article detected by the stock management apparatus 6, it is determined whether or not a selling price that is lower than or equal to a requested purchase price is present, and if a selling price that is lower than or equal to the requested purchase price is present, purchase support information including the selling price and the shop information thereof is notified to the purchase support terminal 2 of the user. Therefore, according to the present example embodiment, the user can purchase a stock shortage article at a lower price.

Note that, while a case where a stock shortage article is detected based on output signals from the weight sensors 608r and 608s and the monitoring cameras 610r and 610s has been described above, the example embodiment is not limited thereto. Any sensor may be installed in a storage place of articles as long as the sensor can detect a change in the stock level of a stored article, and a stock shortage article can be detected based on the output signal of the sensor.

### Third Example Embodiment

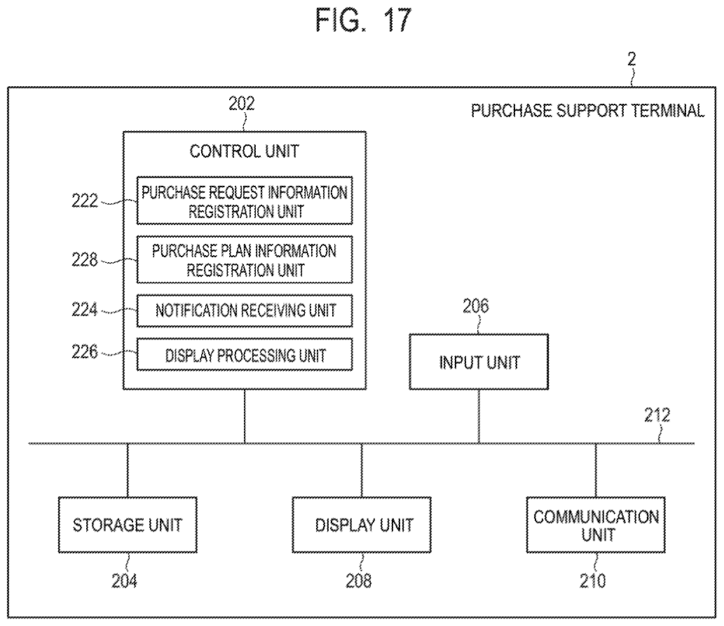

A purchase support system according to the third example embodiment of the present invention will be described with reference to FIG. 17 to FIG. 21. Note that the same components as those in the first and second example embodiments described above are labeled with the same references, and the description thereof will be omitted or simplified.

The basic configuration of the purchase support system according to the present example embodiment is substantially the same as the configuration of the purchase support system according to the first example embodiment. The purchase support system according to the present example embodiment is different from the purchase support system according to the first example embodiment in that the selling price of an article or event information in a shop is managed by using a calendar and a purchase plan notification to perform notification of a purchase plan of the user is performed in addition.

First, the configuration of the purchase support terminal according to the present example embodiment will be described with reference to FIG. 17. FIG. 17 is a block diagram illustrating the configuration of the purchase support terminal according to the present example embodiment.

As illustrated in FIG. 17, the configuration of the purchase support terminal 2 according to the present example embodiment is substantially the same as the configuration in the first example embodiment illustrated in FIG. 2. In the purchase support terminal 2 according to the present example embodiment, the control unit 202 further has a purchase plan information registration unit 228 as function units implemented when the CPU executes a program.

The purchase plan information registration unit 228 functions as a registration unit and transmits and registers purchase plan information on an article based on calendar display described later to the purchase support apparatus 4 via the network 5 by using the communication unit 210. The purchase plan information is input to the purchase support terminal 2 by the user via the input unit 206. Further, the purchase plan information includes a name of an article that the user plans to purchase and a planned purchase price, a name of a planned purchase shop, and a scheduled purchase time for the article, as described later.

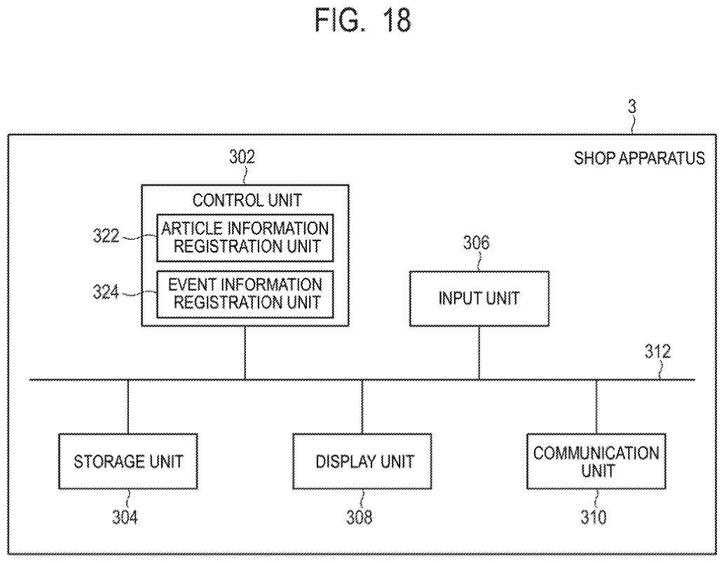

Next, the configuration of a shop apparatus according to the present example embodiment will be described with reference to FIG. 18. FIG. 18 is a block diagram illustrating the configuration of the shop apparatus according to the present example embodiment.

As illustrated in FIG. 18, the configuration of the shop apparatus 3 according to the present example embodiment is substantially the same as the configuration in the first example embodiment illustrated in FIG. 3. In the shop apparatus 3 according to the present example embodiment, the control unit 302 further has an event information registration unit 324 as function units implemented when the CPU executes a program.

Also in the present example embodiment, the article information registration unit 322 transmits and registers article information to the purchase support apparatus 4 in the same manner as in the first example embodiment. However, in addition to a type of an article and a selling price of the article, the article information in the present example embodiment includes a sales time such as a date, a time range, a period, or the like when the article is sold at the selling price.

The event information registration unit 324 functions as a registration unit and transmits and registers event information, which is information regarding an event to be held in a corresponding shop, to the purchase support apparatus 4 via the network 5 by using the communication unit 310. The event information includes the content of an event and an implementation time of the event. The event is not particularly limited but may be, for example, a campaign for extra privilege points, a campaign for a gift, a special sale fair, a local product exhibition, a show, or the like.

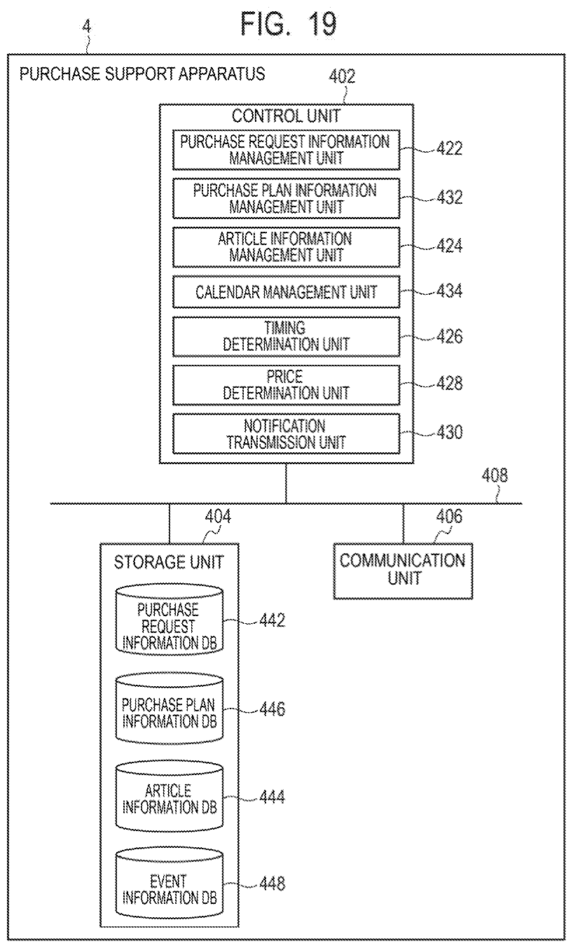

Next, the configuration of the purchase support apparatus according to the present example embodiment will be described with reference to FIG. 19. FIG. 19 is a block diagram illustrating the configuration of the purchase support apparatus according to the present example embodiment.

As illustrated in FIG. 19, the configuration of the purchase support apparatus 4 according to the present example embodiment is substantially the same as the configuration in the first example embodiment illustrated in FIG. 4. In the purchase support apparatus 4 according to the present example embodiment, the control unit 402 has a purchase plan information management unit 432 and a calendar management unit 434 as function units implemented when the CPU executes a program.

The purchase plan information management unit 432 functions as a management unit and manages purchase plan information transmitted from the purchase support terminal 2 to the purchase support apparatus 4 as described above. The purchase plan information management unit 432 registers and manages purchase plan information in a purchase plan information DB 446 stored in the storage unit 404.

The calendar management unit 434 functions as a management unit and manages, on a calendar, event information transmitted from the shop apparatus 3 to the purchase support apparatus 4 as described above. The calendar management unit 434 can register and manage event information in an event information DB 448 stored in the storage unit 404.

Further, the calendar management unit 434 transmits calendar information to the purchase support terminal 2 via the network 5 by using the communication unit 406 in response to a request from the purchase support terminal 2. The calendar information transmitted by the calendar management unit 434 includes article information including a sales time within a predetermined period on a week basis, a month basis, or the like, for example, and event information including an implementation time within the same predetermined period.

Further, in the present example embodiment, the notification transmission unit 430 transmits a purchase plan notification, which is a notification to notify the user of a purchase plan as described later, to the purchase support terminal 2 via the network 5 by using the communication unit 406.

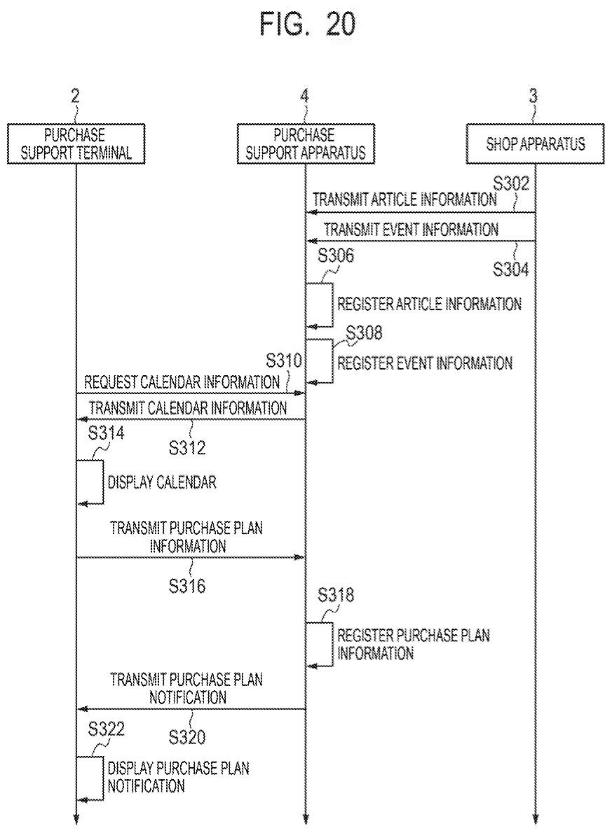

In the purchase support system according to the present example embodiment, it is possible not only to transmit a purchase support notification to the purchase support terminal 2 in the same manner as in the first example embodiment but also to transmit a purchase plan notification based on calendar information to the purchase support terminal 2. The process for the above in the purchase support system will be described below with reference to FIG. 20. FIG. 20 is a sequence diagram illustrating the process in the purchase support system according to the present example embodiment.

The article information registration unit 322 of the shop apparatus 3 transmits article information input by a shop proprietor to the purchase support apparatus 4 via the network 5 in the same manner as in the first example embodiment (step S302). In addition to the name of an article to be sold at the shop and the shop selling price of the article, the article information in the present example embodiment includes a sales time when an article is sold at the selling price.

Further, event information is input to the shop apparatus 3 via the input unit 306 by the shop proprietor. The event information registration unit 324 of the shop apparatus 3 transmits the event information input by the shop proprietor to the purchase support apparatus 4 via the network 5 (step S304). The event information includes the content of an event to be held at the shop and an implementation time of the event.

In the purchase support apparatus 4 to which the article information and the event information have been transmitted from the shop apparatus 3, the article information management unit 424 registers the transmitted article information in the article information DB 444 (step S306) and updates the article information DB 444 in the same manner as in the first example embodiment. Further, the calendar management unit 434 registers the event information in the event information DB 448 (step S308). Thereby, the calendar management unit 434 updates the event information DB 448.

In such a way, registration of the article information and the event information in the purchase support apparatus 4 is performed. The registration of the article information and the event information is repeatedly performed, if necessary, at any timing in accordance with the shop proprietor's needs. Further, order of the registration of the article information and the registration of the event information is not particularly limited and may be performed at timings independent of each other.

On the other hand, a calendar display instruction instructed by the user via the input unit 206 to display a calendar is input to the purchase support terminal 2. In response to the input of the calendar display instruction, the control unit 202 of the purchase support terminal 2 requests calendar information from the purchase support apparatus 4 (step S310).

In response to receiving the request of calendar information from the purchase support terminal 2, the calendar management unit 434 of the purchase support apparatus 4 transmits the calendar information to the purchase support terminal 2 (step S312). The calendar information includes article information including a sales time within a predetermined period and an event information including an implementation time within the same predetermined period.

In response to transmission of the calendar information from the purchase support apparatus 4, the display processing unit 226 of the purchase support terminal 2 causes the display unit 208 to display calendar display based on the transmitted calendar information (step S314). In the calendar display displayed on the display unit 208, the article information and the event information included in the calendar information are displayed on a calendar.

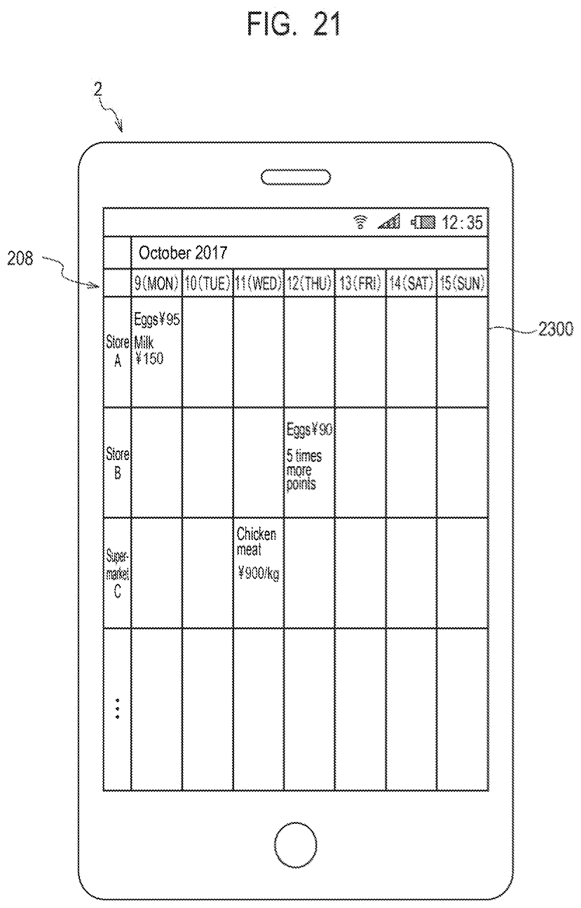

FIG. 21 is a schematic diagram illustrating one example of a screen that displays calendar display in the purchase support terminal 2 according to the present example embodiment. As illustrated in FIG. 21, the display processing unit 226 causes the display unit 208 to display a calendar screen 2300 indicating a calendar. In addition, the display processing unit 226 can causes article information and event information to be displayed on the calendar displayed on the calendar screen 2300 with respective sale time and implementation time being associated with the date in the calendar. FIG. 21 illustrates a case where a calendar is indicated on a week basis and article information and event information are displayed for each shop. Note that the display form of a calendar is not limited to the above, and a calendar may be displayed on a month basis, or a calendar may be displayed on an arbitrary-days basis, for example.

The user who sees the calendar display displayed on the purchase support terminal 2 in such a way is able to plan a purchase schedule for an article indicated in the article information by taking the article information and event information displayed on the calendar into consideration. The user inputs purchase plan information, which is information regarding a purchase schedule of a planned article, to the purchase support terminal 2 via the input unit 206. The purchase plan information corresponds to any of the article information indicated on a calendar and includes a name of an article that the user plans to purchase, a planned purchase price of the article, a name of a planned purchase shop, and a scheduled purchase time. The scheduled purchase time is a scheduled purchase date and time including a scheduled purchase deadline date and further time, for example. Further, the user can input a notification timing to receive a purchase plan notification, which is a notification to report a purchase plan, to the purchase support terminal 2 via the input unit 206 and set the notification timing. In such a case, the purchase plan information also includes a notification timing.

The purchase plan information registration unit 228 of the purchase support terminal 2 transmits, to the purchase support apparatus 4 via the network 5, the purchase plan information input by the user (step S316).

In the purchase support apparatus 4 to which the purchase plan information has been transmitted from the purchase support terminal 2, the purchase plan information management unit 432 registers the transmitted purchase plan information in the purchase plan information DB 446 (step S318). Thereby, the purchase plan information management unit 432 updates the purchase plan information DB 446.

The notification transmission unit 430 of the purchase support apparatus 4 monitors arrival of a scheduled purchase time for purchase plan information registered in the purchase plan information DB 446 or, when the notification timing has been set, monitors arrival of the notification timing. The notification transmission unit 430 then transmits a purchase plan notification, which reports a purchase plan, to the purchase support terminal 2 by push notification via the network 5 for purchase plan information for which the scheduled purchase time or notification timing has arrived (step S320).

In response to transmission of the purchase plan notification from the purchase support apparatus 4 to the purchase support terminal 2, the notification receiving unit 224 of the purchase support terminal 2 receives the transmitted purchase plan notification. Next, the display processing unit 226 of the purchase support terminal 2 causes the display unit 208 to display the purchase plan notification received by the notification receiving unit 224 (step S322). The display processing unit 226 can cause the display unit 208 to display the purchase support information in various schemes such as banner display, dialog display, display in a notification area, display in a lock screen, or the like, for example. The purchase plan notification displayed in such a way enables the user to know that the scheduled purchase time has arrived or arrival of the scheduled purchase time is coming soon.

As described above, according to the present example embodiment, since a purchase plan notification that reports a purchase plan is transmitted to the purchase support terminal 2, an article planned to be purchased can be more reliably purchased.

Note that, while the case where a purchase plan notification is transmitted in the first example embodiment has been described above, a purchase plan notification can be transmitted also in the second example embodiment in the same manner as above.

### Fourth Example Embodiment

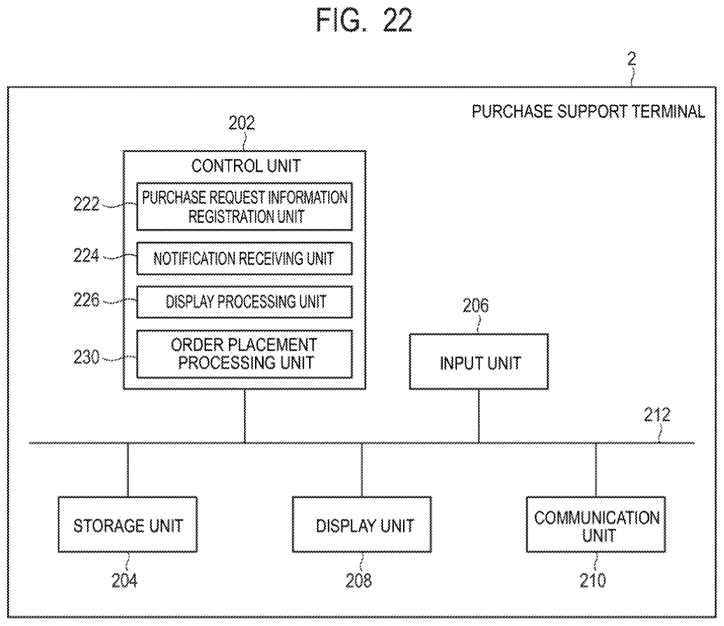

A purchase support system according to the fourth example embodiment of the present invention will be described with reference to FIG. 22 to FIG. 24. Note that the same components as those in the first to third example embodiments are labeled with the same references, and the description thereof will be omitted or simplified.

The basic configuration of the purchase support system according to the present example embodiment is substantially the same as the configuration of the purchase support system according to the first example embodiment. The purchase support system according to the present example embodiment is different from the purchase support system according to the first example embodiment in that the purchase support terminal 2 is configured to be able to perform an order placement process for an article notified by a purchase support notification.

First, the configuration of the purchase support terminal according to the present example embodiment will be described with reference to FIG. 22. FIG. 22 is a block diagram illustrating the configuration of the purchase support terminal according to the present example embodiment.

As illustrated in FIG. 22, the configuration of the purchase support terminal 2 according to the present example embodiment is substantially the same as the configuration in the first example embodiment illustrated in FIG. 2. In the purchase support terminal 2 according to the present example embodiment, the control unit 202 further has an order placement processing unit 230 as function units implemented when the CPU executes a program.

The order placement processing unit 230 transmits, to the shop apparatus 3 corresponding to a shop that sells the article, order placement information on an article notified by a purchase support notification via the network 5 by using the communication unit 210 and performs an order placement process. The order placement information is input to the purchase support terminal 2 by the user via the input unit 206. The order placement information includes a name of an article ordered by the user, a selling price, a purchase quantity, ordering party information, payment information, a data and time of visiting the shop, or the like, for example. The ordering party information is information for identifying a user who is the ordering party, such as a name of the user, a user ID, a contact address, or the like. The payment information is information regarding a payment scheme such as credit card information, electronic money information used by the user for payment of a charge of the ordered article. Further, the data and time of visiting the shop is a scheduled date and time when the user comes to the shop to receive the ordered item.

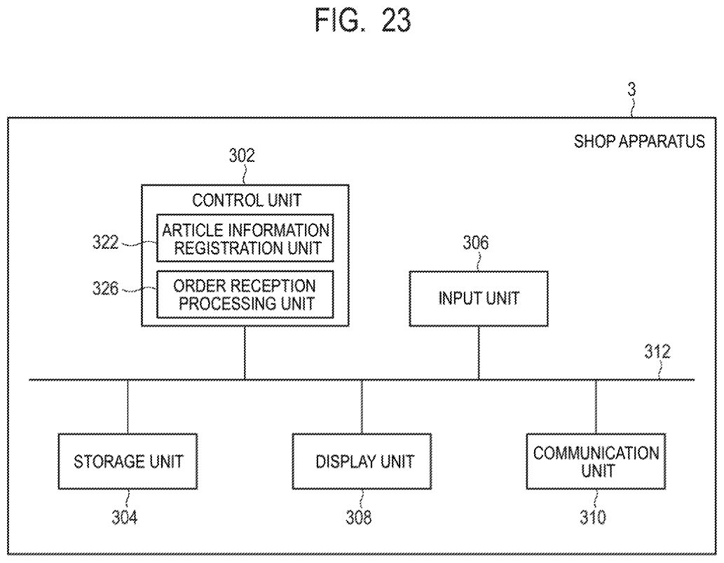

Next, the configuration of the shop apparatus according to the present example embodiment will be described with reference to FIG. 23. FIG. 23 is a block diagram illustrating the configuration of the shop apparatus according to the present example embodiment.

As illustrated in FIG. 23, the configuration of the shop apparatus 3 according to the present example embodiment is substantially the same as the configuration in the first example embodiment illustrated in FIG. 3. In the shop apparatus 3 according to the present example embodiment, the control unit 302 further has an order reception processing unit 326 as function units implemented when the CPU executes a program.

The order reception processing unit 326 performs an order reception process in response to order placement information transmitted from the purchase support terminal 2. For example, the order reception process includes transmission of an order reception acknowledgement message to the purchase support terminal 2, creation and recording of the order reception information corresponding to the order placement information, and instruction of checking the stock of an article and arranging an article.

Further, the order reception processing unit 326 also functions as a payment processing unit and pays a charge of an ordered article by using payment information included in the order placement information. Note that the payment process may be performed by a payment apparatus such as a payment server connected to the network 5 independently of the shop apparatus 3.

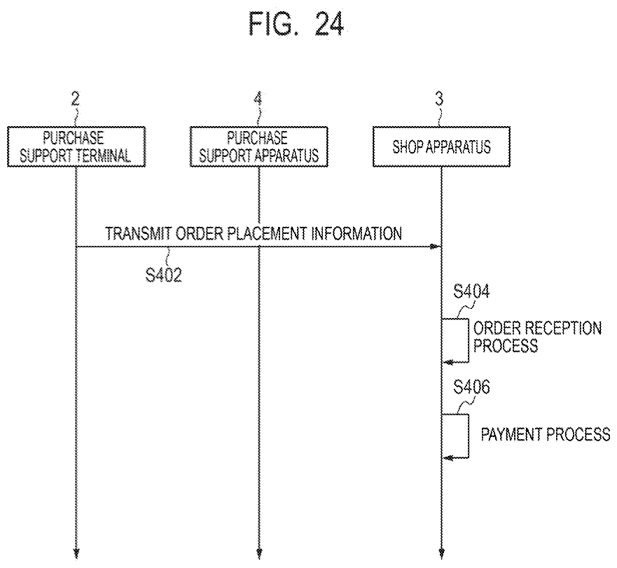

In the purchase support system according to the present example embodiment, it is possible not only to transmit a purchase support notification to the purchase support terminal 2 in the same manner as in the first example embodiment but also to perform an order placement process from the purchase support terminal 2 for an article notified by the purchase support notification. The process for the above in the purchase support system will be described below with reference to FIG. 24. FIG. 24 is a sequence diagram illustrating the process in the purchase support system according to the present example embodiment.

The user who has received a purchase support notification by the purchase support terminal 2 considers purchase support information such as a selling price notified by the purchase support notification to determine whether or not to purchase the article in the same manner as in the first example embodiment. The user who has determined purchase of the article notified by the purchase support notification inputs order placement information used for purchase of the article to the purchase support terminal 2 via the input unit 206. The order placement information includes a name of an article ordered by the user, a selling price, a purchase quantity, ordering party information, payment information, a date and time of visiting the shop, or the like, for example.

The order placement processing unit 230 of the purchase support terminal 2 transmits the order placement information input by the user, via the network 5, to the shop apparatus 3 corresponding to a shop which sells the ordered item (step S402).

In the shop apparatus 3 to which the order placement information has been transmitted from the purchase support terminal 2, the order reception processing unit 326 performs an order reception process for the order placement (step S404). In the order reception process, the order reception processing unit 326 transmits an order reception acknowledgement message, which acknowledges reception of the order placement, to the purchase support terminal 2 that has transmitted the order placement information, for example. Further, the order reception processing unit 236 creates order reception information corresponding to order placement information, for example. The order reception information can be recorded and managed in a DB stored in the storage unit 304, for example.

Further, in the order reception process, the order reception processing unit 326 causes the display unit 308 to display the name of an article and the date and time of the ordering user visiting the shop included in the order placement information and instructs shop staff to arrange the article, for example. The staff instructed to arrange the article is able to recognize the date and time of the user visiting the shop and arrange the ordered article by the date and time of vising the shop.

Further, the order reception processing unit 326 functions as a payment processing unit and performs a payment process on the charge for the ordered article by using payment information included in the order placement information (step S406). Note that the payment process may be performed by a payment server or the like independent of the shop apparatus 3.

As described above, according to the present example embodiment, since an order placement process can be performed from the purchase support terminal 2 for an article notified by a purchase support notification, the user can purchase an article without missing the right time to make a purchase.

Note that, while the case where an order placement process is performed from the purchase support terminal 2 has been described above in the first example embodiment, an order placement process can be performed from the purchase support terminal 2 in the same manner as above in the second and third example embodiments.

### Fifth Example Embodiment

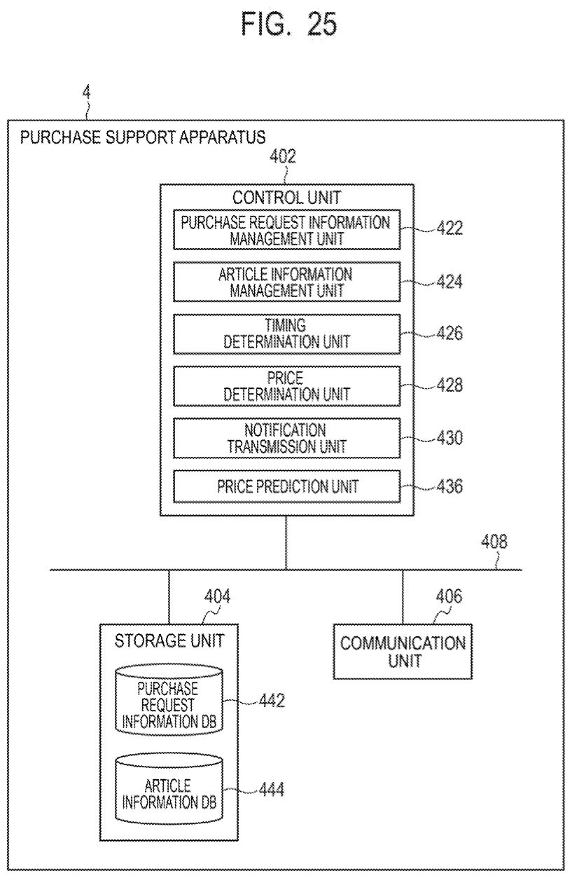

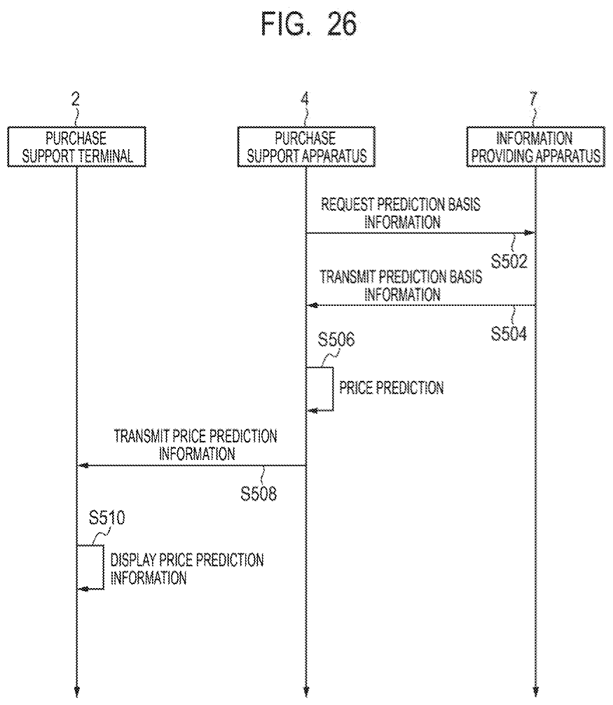

A purchase support system according to the fifth example embodiment of the present invention will be described with reference to FIG. 25 and FIG. 26. Note that the same components as those in the first to fourth example embodiments described above are labeled with the same references, and the description thereof will be omitted or simplified.

The basic configuration of the purchase support system according to the present example embodiment is substantially the same as the configuration of the purchase support system according to the first example embodiment. The purchase support system according to the present example embodiment is different from the purchase support system according to the first example embodiment in that the purchase support apparatus 4 performs price prediction on an article registered in the purchase request information DB 442.

First, the configuration of the purchase support apparatus according to the present example embodiment will be described with reference to FIG. 25. FIG. 25 is a block diagram illustrating the configuration of the purchase support apparatus according to the present example embodiment.

As illustrated in FIG. 25, the configuration of the purchase support apparatus 4 according to the present example embodiment is substantially the same as the configuration in the first example embodiment illustrated in FIG. 4. In the purchase support apparatus 4 according to the present example embodiment, the control unit 402 further has a price prediction unit 436 as function units implemented when the CPU executes a program.

The price prediction unit 436 functions as a prediction unit and performs price prediction to generate price prediction information for an article registered in the purchase request information DB 442. The price prediction information corresponds to a price, a price range, or a coefficient of price fluctuation predicted for the future, for example. Further, the price prediction information may be information generally indicating only whether the price is in a rising trend or a falling trend.

To perform price prediction, the price prediction unit 436 acquires prediction basis information from the information providing apparatus 7 via the network 5 by using the communication unit 406. The purchase support apparatus 4 can acquire prediction basis information from one or a plurality of information providing apparatuses 7. The purchase support apparatus 4 performs price prediction based on the prediction basis information. The scheme used for price prediction by the purchase support apparatus 4 is not particularly limited, and any schemes may be used, for example, a scheme using artificial intelligence (AI) may be used.

The information providing apparatus 7 is an information providing server connected to the network 5 and provides prediction basis information that may affect the price trend of an article. The prediction basis information is not particularly limited but may be, for example, news information, weather information, exchange rate information, or the like. The information providing apparatus 7 transmits and provides prediction basis information to the purchase support apparatus 4 via the network 5 upon a request by the purchase support apparatus 4.

Further, a prediction basis information DB in which prediction basis information is databased may be stored in the storage unit 404 of the purchase support apparatus 4. The purchase support apparatus 4 can also perform price prediction based on the prediction basis information in the prediction basis information DB. Note that the form of prediction basis information used in price prediction by the purchase support apparatus 4 is not particularly limited, and various forms of prediction basis information in addition to a server-provided form or a databased form can be used for price prediction.

The purchase support apparatus 4 transmits price prediction information generated by performing price prediction to the purchase support terminal 2, which has registered purchase request information for an article on which the price prediction is performed, via the network 5 by using the communication unit 406. The purchase support apparatus 4 can include price prediction information in a purchase support notification and transmit the purchase support information to the purchase support terminal 2. That is, the purchase support apparatus 4 can transmit purchase support information and price prediction information regarding the same article to the purchase support terminal 2 at the same time. Further, the purchase support apparatus 4 can also transmit price prediction information to the purchase support terminal 2 independently of a purchase support notification.

In the purchase support system according to the present example embodiment, it is possible not only to transmit a purchase support notification to the purchase support terminal 2 in the same manner as in the first example embodiment but also to transmit price prediction information generated by price prediction for an article registered in the purchase request information DB 442. The process for the above in the purchase support system will be described below with reference to FIG. 26. FIG. 26 is a sequence diagram illustrating the process of the purchase support system according to the present example embodiment.

In performing price prediction, first, the price prediction unit 436 of the purchase support apparatus 4 requests prediction basis information from the information providing apparatus 7 via the network 5 (step S502).

The information providing apparatus 7 that has received the request of prediction basis information transmits prediction basis information to the purchase support apparatus 4 via the network 5 (step S504).

The purchase support apparatus 4 performs price prediction on an article registered in the purchase request information DB 442 based on the prediction basis information transmitted from the information providing apparatus 7 (step S506). Thereby, the purchase support apparatus 4 generates price prediction information for an article registered in the purchase request information DB 442. Note that the purchase support apparatus 4 may perform price prediction upon a request by the purchase support terminal 2 or may perform price prediction at a timing set in advance by the user or any timing.

For example, the purchase support apparatus 4 analyzes weather information as prediction basis information and, when determining that it will be a cool summer, predicts a rise in the price of vegetables after the summer based on the past price trend of vegetables. Further, for example, the purchase support apparatus 4 acquires news information having the content of “saury poor catch” as prediction basis information and predicts a future rise in the price of sauries based on the past landing of sauries and the ensuing price change of sauries.

Next, the price prediction unit 436 of the purchase support apparatus 4 transmits the price prediction information via the network 5 to the purchase support terminal 2 that has registered the purchase request information for the article on which the price prediction has been performed (step S508).

The display processing unit 226 of the purchase support terminal 2 to which the price prediction information has been transmitted causes the display unit 208 to display the transmitted price prediction information (step S510). The display processing unit 226 can cause the display unit 208 to display the price prediction information in various schemes such as banner display, dialog display, display in a notification area, display in a lock screen, or the like, for example, in the same manner as the case of purchase support information included in a purchase support notification.

Based on the price prediction information displayed on the purchase support terminal 2, the user may consider a purchasing timing, a purchasing quantity, or the like for an article for which price prediction information is indicated.

As described above, according to the present example embodiment, since price prediction information is transmitted from the purchase support apparatus 4 to the purchase support terminal 2, the user can purchase an article taking the price prediction information into consideration. Therefore, according to the present example embodiment, the user can purchase an article suitably in accordance with a price trend in article information.

### Sixth Example Embodiment

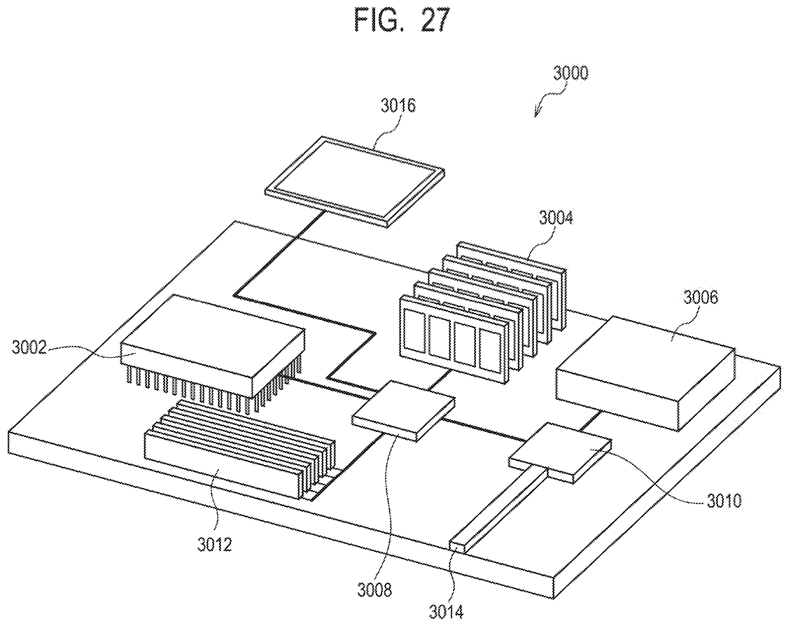

A computer device according to the sixth example embodiment of the present invention will be described with reference to FIG. 27. In the present example embodiment, a computer apparatus used for implementing the process of each unit in the purchase support system according to the first to fifth example embodiments described above will be described.

FIG. 27 illustrates an example of a computer apparatus used for implementing the process of each unit in the purchase support system according to the first to fifth example embodiments described above. A computer apparatus 3000 illustrated in FIG. 27 is not particularly limited but may be of various types or forms. For example, the computer apparatus 3000 may be a smartphone, a tablet computer, a laptop computer, or a desktop computer. Further, the computer apparatus 3000 may be, for example, a workstation, a personal digital assistant, a server, a blade server, a mainframe, an embedded system, or the like.

The computer apparatus 3000 has a processor 3002, a memory 3004, and a storage device 3006. Further, the computer apparatus 3000 has a high-speed controller 3008 including a high-speed interface and a low-speed controller 3010 including a low-speed interface. The memory 3004 and a high-speed expansion port 3012 are connected to the high-speed controller 3008. Further, an external input/output device such as a display 3016 or the like is connected to the high-speed controller 3008. On the other hand, a low-speed expansion port 3014 and the storage device 3006 are connected to the low-speed controller 3010.

The processor 3002, the memory 3004, the storage device 3006, the high-speed controller 3008, the low-speed controller 3010, and the high-speed expansion port 3012 are connected to each other through various buses. Further, the processor 3002, the memory 3004, the storage device 3006, the high-speed controller 3008, the low-speed controller 3010, and the high-speed expansion port 3012 may be implemented on a common motherboard or may be implemented in other forms as appropriate.

The processor 3002 is a CPU, for example, and is able to process instructions executed within the computer apparatus 3000. Such instructions include an instruction that is used for displaying graphics information of a graphical user interface (GUI) on an external input/output device such as the display 3016 and stored in the memory 3004 or the storage device 3006.

Further, a plurality of processors, a plurality of busses, or a plurality of processors and a plurality of busses can be used as appropriate together with a plurality of memory devices and multiple types of memory devices. Further, a plurality of computer apparatuses 3000 can be connected to each device that performs a part of the necessary process. For example, a plurality of computer apparatuses 3000 can be connected to each other as a server bank, a group of blade servers, or a multiprocessor system.

The memory 3004 stores therein information within the computer apparatus 3000. For example, the memory 3004 may be a volatile memory unit or a non-volatile memory unit. The memory 3004 may be another computer readable medium, such as a magnetic disk, an optical disk, or the like, for example.

The storage device 3006 can form mass storage used for the computer apparatus 3000. The storage device 3006 may be a computer readable medium or include such a computer readable medium. A computer readable medium may be, for example, a floppy (registered trademark) disk device, a hard disk device, an optical disk device, a tape device, a solid state memory device such as flash memory or the like, a disk array, or the like. The storage device 3006 may include a storage area network or a device with another configuration. A computer program product may be tangibly embodied in an information carrier. The computer program product can also store an instruction that executes one or a plurality of processes as described above when executed. The information carrier may be a memory device such as the memory 3004, the storage device 3006, or the memory on the processor 3002 or may be a computer readable medium or a machine readable medium such as a carrier signal.

The high-speed controller 3008 manages processes in which the bandwidth for the computer apparatus 3000 is intensively used. On the other hand, the low-speed controller 3010 manages processes in which the bandwidth is less intensively used. However, such allocation of the functions is a mere example, and allocation is not limited thereto. Further, a part or a whole of the high-speed controller 3008 may be incorporated in the processor 3002.

The high-speed controller 3008 is connected to the high-speed expansion port 3012 that can accept the memory 3004 and various expansion cards. Further, the high-speed controller 3008 is connected to the display 3016 via a graphics processor or an accelerator, for example. The display 3016 is a liquid crystal display, an OLED display, or the like and may be an external display or an integrated display integrated with a casing. Further, the display 3016 may be configured as a touchscreen that functions not only as a display device but also as an input device.

Further, the low-speed controller 3010 is connected to the storage device 3006 and the low-speed expansion port 3014. The low-speed expansion port 3014 can include, for example, a communication port of various standards such as Universal Serial Bus (USB), Bluetooth (registered trademark), wired or wireless Ethernet (registered trademark), or the like. One or plurality of input/output devices such as a keyboard, a pointing device, a scanner, or the like can be connected to the low-speed expansion port 3014. Further, one or plurality of network devices such as a switch, a router, or the like can be connected to the low-speed expansion port 3014 via a network adapter, for example.

The computer apparatus 3000 can be implemented in many different forms. For example, the computer apparatus 3000 can be implemented in a form of a typical server or a plurality of servers in a form of a group of such servers. Further, the computer apparatus 3000 can be implemented as a part of the rack server system. Furthermore, the computer apparatus 3000 can be implemented in a form of a personal computer such as a laptop computer, a desktop computer, or the like.

The computer apparatus 3000 described above can function as the purchase support terminal 2 in the example embodiments described above. In such a case, the processor 3002 of the computer apparatus 3000 can function as the control unit 202 by executing a program that implements the function of the control unit 202 of the purchase support terminal 2. That is, the processor 3002 executes programs that implement the functions of respective units of the purchase request information registration unit 222, the notification receiving unit 224, the display processing unit 226, the purchase plan information registration unit 228, and the order placement processing unit 230. Thereby, the processor 3002 can function as each unit of the purchase request information registration unit 222, the notification receiving unit 224, the display processing unit 226, the purchase plan information registration unit 228, and the order placement processing unit 230. Further, the storage device 3006 of the computer apparatus 3000 can function as the storage unit 204 of the purchase support terminal 2.

Further, the computer apparatus 3000 can function as the shop apparatus 3 in the example embodiments described above. In such a case, the processor 3002 of the computer apparatus 3000 can function as the control unit 302 by executing a program that implements the function of the control unit 302 of the shop apparatus 3. That is, the processor 3002 executes programs that implement the functions of respective units of the article information registration unit 322, the event information registration unit 324, and the order reception processing unit 326. Thereby, the processor 3002 can function as each unit of the article information registration unit 322, the event information registration unit 324, and the order reception processing unit 326. Further, the storage device 3006 of the computer apparatus 3000 can function as the storage unit 304 of the shop apparatus 3.

Further, the computer apparatus 3000 can function as the purchase support apparatus 4 in the example embodiments described above. In such a case, the processor 3002 of the computer apparatus 3000 can function as the control unit 402 by executing a program that implements the function of the control unit 402 of the purchase support apparatus 4. That is, the processor 3002 executes programs that implement the functions of respective units of the purchase request information management unit 422, the article information management unit 424, the timing determination unit 426, the price determination unit 428, and the notification transmission unit 430. Further, the processor 3002 executes programs that implement the functions of respective units of the purchase plan information management unit 432, the calendar management unit 434, and the price prediction unit 436. Thereby, the processor 3002 can function as each unit of the purchase request information management unit 422, the article information management unit 424, the timing determination unit 426, the price determination unit 428, and the notification transmission unit 430. Further, the processor 3002 can function as each unit of the purchase plan information management unit 432, the calendar management unit 434, and the price prediction unit 436.

Further, the computer apparatus 3000 can function as the stock management apparatus 6 in the example embodiments described above. In such a case, the processor 3002 of the computer apparatus 3000 can function as the control unit 602 by executing a program that implements the function of the control unit 602 of the stock management apparatus 6. That is, the processor 3002 executes programs that implement the functions of respective units of the signal acquisition unit 622, the stock level calculation unit 624, and the stock determination unit 626. Thereby, the processor 3002 can function as each unit of the signal acquisition unit 622, the stock level calculation unit 624, and the stock determination unit 626.

Note that a part or a whole of the program executed by the processor 3002 of the computer apparatus 3000 can be provided by a computer readable storage medium storing the above, such as a digital versatile disc-read only memory (DVD-ROM), a compact disc-read only memory (CD-ROM), a flash memory such as a USB memory or the like.

### OTHER EXAMPLE EMBODIMENTS

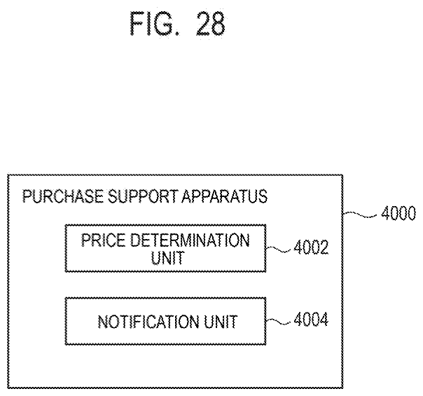

The purchase support apparatus described in each of the above example embodiments can also be configured as illustrated in FIG. 28 according to another example embodiment. FIG. 28 is a block diagram illustrating a function configuration of a purchase support apparatus according to another example embodiment.

As illustrated in FIG. 28, the purchase support apparatus 4000 according to another example embodiment has a price determination unit 4002 that compares a requested purchase price of an article registered by a user with a selling price at a shop for the article and determines whether or not a selling price is lower than or equal to the requested purchase price. Further, the purchase support apparatus 4000 has a notification unit 4004 that, when it is determined by the price determination unit 4002 that the selling price is lower than or equal to the requested purchase price, notifies the user of information regarding the selling price and the shop.

According to the purchase support apparatus 4000 in accordance with another example embodiment, the user can make a purchase at a timing when the user wishes to make a purchase.

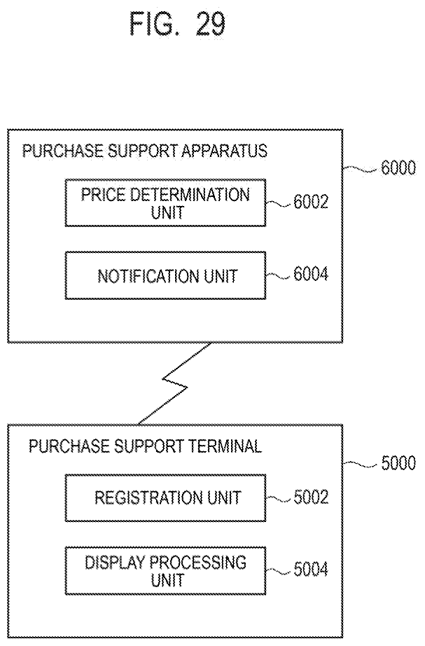

Further, the purchase support terminal described in each of the above example embodiments can be configured as illustrated in FIG. 29 according to another example embodiment. FIG. 29 is a block diagram illustrating a function configuration of a purchase support terminal according to another example embodiment.

As illustrated in FIG. 29, a purchase support terminal 5000 according to another example embodiment is configured to be able to communicate with a purchase support apparatus 6000. The purchase support apparatus 6000 has a price determination unit 6002 that compares a requested purchase price of a registered article with a selling price at a shop for the article and determines whether or not the selling price is lower than or equal to the requested purchase price. Further, the purchase support apparatus 6000 has a notification unit 6004 that, when it is determined by the price determination unit 6002 that the selling price is lower than or equal to the requested purchase price, performs notification of information regarding the selling price and the shop.

The purchase support terminal 5000 according to another example embodiment has a registration unit 5002 that registers a requested purchase price of an article that a user wishes to purchase. Further, the purchase support terminal 5000 has a display processing unit 5004 that causes a display unit to display information regarding the selling price and the shop notified by the notification unit 6004.

According to the purchase support terminal 5000 in accordance with another example embodiment, the user can make a purchase at a timing when the user wishes to make a purchase.

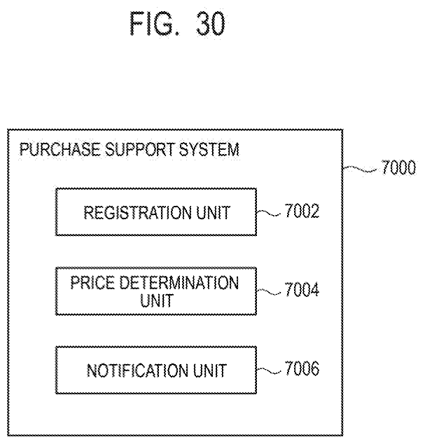

Further, the purchase support system described in each of the above example embodiments can be configured as illustrated in FIG. 30 according to another example embodiment. FIG. 30 is a block diagram illustrating a function configuration of a purchase support system according to another example embodiment.

As illustrated in FIG. 30, a purchase support system 7000 according to another example embodiment has a registration unit 7002 that registers a requested purchase price of an article that a user wishes to purchase. Further, the purchase support system 7000 has a price determination unit 7004 that compares a requested purchase price of an article registered by the registration unit 7002 with a selling price at a shop for the article and determines whether or not the selling price is less than or equal to the requested purchase price. Further, the purchase support system 7000 has a notification unit 7006 that, when it is determined by the price determination unit 7004 that the selling price is lower than or equal to the requested purchase price, notifies the user of information regarding the selling price and the shop.

According to the purchase support system 7000 in accordance with another example embodiment, the user can make a purchase at a timing when the user wishes to make a purchase.

### MODIFIED EXAMPLE EMBODIMENTS

The present invention is not limited to the example embodiments described above, and various modifications are possible.

For example, while the case where the purchase support apparatus 4 is installed independently of the purchase support terminal 2 has been described as examples in the above example embodiments, the present invention is not limited thereto. For example, the purchase support terminal 2 may be configured to have a part or the whole of the function of the purchase support apparatus 4.

Further, the scope of each of the example embodiments includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the computer program described above is stored but also the computer program itself.

As the storage medium, for example, a floppy (registered trademark) disk, a hard disk, an optical disk, a magneto-optical disk, a DVD-ROM, a CD-ROM, a magnetic tape, a nonvolatile memory card, or a ROM can be used. Further, the scope of each of the example embodiments includes an example that operates on Operating System (OS) to perform a process in cooperation with another software or a function of an add-in board without being limited to an example that performs a process by an individual program stored in the storage medium.

The service realized by the functions of each example embodiment described above may be provided to a user in a form of Software as a Service (SaaS).

The whole or part of the example embodiments disclosed above can be described as, but not limited to, the following supplementary notes.

(Supplementary Note 1)

A purchase support apparatus comprising:

a price determination unit that compares a requested purchase price of an article registered by a user with a selling price at a shop of the article and determines whether or not the selling price is lower than or equal to the requested purchase price; and

a notification unit that, when it is determined by the price determination unit that the selling price is lower than or equal to the requested purchase price, notifies the user of information regarding the selling price and the shop.

(Supplementary Note 2)

The purchase support apparatus according to supplementary note 1, wherein the price determination unit compares the requested purchase price with the selling price at a plurality of shops registered for the article registered by the user.

(Supplementary Note 3)

The purchase support apparatus according to supplementary note 1 or 2 further comprising a timing determination unit that determines whether or not a ratio of an elapsing period from a previous purchase time of the article to a purchase cycle registered for the article registered by the user is greater than or equal to a predetermined threshold,

wherein when it is determined by the timing determination unit that the ratio is greater than or equal to the predetermined threshold, the price determination unit determines whether or not the selling price is lower than or equal to the requested purchase price.

(Supplementary Note 4)

The purchase support apparatus according to any one of supplementary notes 1 to 3, wherein the article registered by the user is a stock shortage article detected based on an output signal of a sensor installed in a storage place where the user stores the article.

(Supplementary Note 5)

The purchase support apparatus according to any one of supplementary notes 1 to 4 further comprising a price prediction unit that predicts a price of the article registered by the user.

(Supplementary Note 6)

A purchase support terminal configured to be able to communicate with a purchase support apparatus comprising a price determination unit that compares a requested purchase price of a registered article with a selling price at a shop of the article and determines whether or not the selling price is lower than or equal to the requested purchase price and a notification unit that, when it is determined by the price determination unit that the selling price is lower than or equal to the requested purchase price, performs notification of information regarding the selling price and the shop, the purchase support terminal comprising:

a registration unit that registers the requested purchase price of the article that a user wishes to purchase; and

a display processing unit that causes a display unit to display the information regarding the selling price and the shop notified by the notification unit.

(Supplementary Note 7)

The purchase support terminal according to supplementary note 6, wherein the display processing unit causes the information regarding the selling price and the shop notified by the notification unit to be displayed on a map.

(Supplementary Note 8)

The purchase support terminal according to supplementary note 6, wherein the display processing unit causes the information regarding the selling price at the shop of the article and the shop to be displayed on a calendar.

(Supplementary Note 9)

The purchase support terminal according to supplementary note 8, wherein the display processing unit causes information regarding an event of the shop to be displayed on the calendar.

(Supplementary Note 10)

The purchase support terminal according to supplementary note 8 or 9 further comprising another registration unit that registers information regarding a purchase plan of the user for the article based on the information regarding the selling price and the shop displayed on the calendar,

wherein the notification unit notifies the user of the purchase plan.

(Supplementary Note 11)

The purchase support terminal according to any one of supplementary notes 6 to 10 further comprising an order placement processing unit that places an order of the article for which the selling price and the shop are notified by the notification unit.

(Supplementary Note 12)

A purchase support system comprising:

a registration unit that registers a requested purchase price of an article that a user wishes to purchase;

a price determination unit that compares the requested purchase price of the article registered by the registration unit with a selling price at a shop of the article and determines whether or not the selling price is lower than or equal to the requested purchase price; and

a notification unit that, when it is determined by the price determination unit that the selling price is lower than or equal to the requested purchase price, notifies the user of information regarding the selling price and the shop.

(Supplementary Note 13)

A method comprising:

comparing a requested purchase price of an article registered by a user with a selling price at a shop of the article and determining whether or not the selling price is lower than or equal to the requested purchase price; and

when it is determined that the selling price is lower than or equal to the requested purchase price, notifying the user of information regarding the selling price and the shop.

(Supplementary Note 14)

A method in a purchase support terminal configured to be able to communicate with a purchase support apparatus comprising a price determination unit that compares a requested purchase price of a registered article with a selling price at a shop of the article and determines whether or not the selling price is lower than or equal to the requested purchase price and a notification unit that, when it is determined by the price determination unit that the selling price is lower than or equal to the requested purchase price, performs notification of information regarding the selling price and the shop, the method comprising:

registering the requested purchase price of the article that a user wishes to purchase; and

causing a display unit to display the information regarding the selling price and the shop notified by the notification unit.

(Supplementary Note 15)

A storage medium storing a program that causes a computer to perform:

comparing a requested purchase price of an article registered by a user with a selling price at a shop of the article and determining whether or not the selling price is lower than or equal to the requested purchase price; and

when it is determined that the selling price is lower than or equal to the requested purchase price, notifying the user of information regarding the selling price and the shop.

(Supplementary Note 16)

A storage medium storing a program that causes a computer to perform a method in a purchase support terminal configured to be able to communicate with a purchase support apparatus comprising a price determination unit that compares a requested purchase price of a registered article with a selling price at a shop of the article and determines whether or not the selling price is lower than or equal to the requested purchase price and a notification unit that, when it is determined by the price determination unit that the selling price is lower than or equal to the requested purchase price, performs notification of information regarding the selling price and the shop, the program causing the computer to perform:

registering the requested purchase price of the article that a user wishes to purchase; and

causing a display unit to display the information regarding the selling price and the shop notified by the notification unit.

While the present invention has been described above with reference to the example embodiments, the present invention is not limited to the example embodiments described above. Various modifications that may be understood by those skilled in the art within the scope of the present invention can be made to the features or details of the present invention.

This application is based upon and claims the benefit of priority from Japanese Patent Application No. 2017-190393, filed on Sep. 29, 2017, the disclosure of which is incorporated herein in its entirety by reference.

### REFERENCE SIGNS LIST

1 purchase support system
2 purchase support terminal
3 shop apparatus
4 purchase support apparatus
5 network
6 stock management apparatus
7 information providing apparatus

1. A purchase support apparatus comprising:
at least one memory configured to store instructions; and
at least one processor configured to execute the instructions to:
compare a requested purchase price of an article registered by a user with a selling price at a shop of the article and determines whether or not the selling price is lower than or equal to the requested purchase price; and
when it is determined that the selling price is lower than or equal to the requested purchase price, notify the user of information regarding the selling price and the shop.

2. The purchase support apparatus according to claim 1, wherein the at least one processor is configured to execute the instructions to:
compare the requested purchase price with the selling price at a plurality of shops registered for the article registered by the user.

3. The purchase support apparatus according to claim 1, wherein the at least one processor is further configured to execute the instructions to:
determine whether or not a ratio of an elapsing period from a previous purchase time of the article to a purchase cycle registered for the article registered by the user is greater than or equal to a predetermined threshold,
wherein when it is determined that the ratio is greater than or equal to the predetermined threshold, the at least one processor determines whether or not the selling price is lower than or equal to the requested purchase price.

4. The purchase support apparatus according to claim 1, wherein the article registered by the user is a stock shortage article detected based on an output signal of a sensor installed in a storage place where the user stores the article.

5. The purchase support apparatus according to claim 1, wherein the at least one processor is further configured to execute the instructions to:
predict a price of the article registered by the user.

6. A purchase support terminal configured to be able to communicate with a purchase support apparatus comprising: at least one first memory configured to store instructions; and at least one first processor configured to execute the instructions to: compare a requested purchase price of a registered article with a selling price at a shop of the article; determine whether or not the selling price is lower than or equal to the requested purchase price; and when it is determined that the selling price is lower than or equal to the requested purchase price, perform notification of information regarding the selling price and the shop, the purchase support terminal comprising:
at least one second memory configured to store instructions; and
at least one second processor configured to execute the instructions to:
register the requested purchase price of the article that a user wishes to purchase; and
cause a display unit to display the information regarding the selling price and the shop notified by the at least one first processor.

7. The purchase support terminal according to claim 6, wherein the at least one second processor is configured to execute the instructions to:
cause the information regarding the selling price and the shop notified by the at least one first processor to be displayed on a map.

8. The purchase support terminal according to claim 6, wherein the at least one second processor is configured to execute the instructions to:
cause the information regarding the selling price at the shop of the article and the shop to be displayed on a calendar.

9. The purchase support terminal according to claim 8, wherein the at least one second processor is configured to execute the instructions to:
cause information regarding an event of the shop to be displayed on the calendar.

10. The purchase support terminal according to claim 8, wherein the at least one second processor is further configured to execute the instructions to:
register information regarding a purchase plan of the user for the article based on the information regarding the selling price and the shop displayed on the calendar,
wherein the at least one first processor is configured to execute the instructions to:
notify the user of the purchase plan.

11. The purchase support terminal according to claim 6, wherein the at least one second processor is further configured to execute the instructions to:
place an order of the article for which the selling price and the shop are notified by the notification unit.

13. A method comprising:
comparing a requested purchase price of an article registered by a user with a selling price at a shop of the article and determining whether or not the selling price is lower than or equal to the requested purchase price; and
when it is determined that the selling price is lower than or equal to the requested purchase price, notifying the user of information regarding the selling price and the shop.

17. The purchase support apparatus according to claim 2, wherein the at least one processor is further configured to execute the instructions to:
determine whether or not a ratio of an elapsing period from a previous purchase time of the article to a purchase cycle registered for the article registered by the user is greater than or equal to a predetermined threshold,
wherein when it is determined that the ratio is greater than or equal to the predetermined threshold, the at least one processor determines whether or not the selling price is lower than or equal to the requested purchase price.

18. The purchase support apparatus according to claim 2, wherein the article registered by the user is a stock shortage article detected based on an output signal of a sensor installed in a storage place where the user stores the article.

19. The purchase support apparatus according to claim 2, wherein the at least one processor is further configured to execute the instructions to:
predict a price of the article registered by the user.

20. The purchase support terminal according to claim 9, wherein the at least one second processor is further configured to execute the instructions to:
register information regarding a purchase plan of the user for the article based on the information regarding the selling price and the shop displayed on the calendar,
wherein the at least one first processor is configured to execute the instructions to:
notify the user of the purchase plan.

21. The purchase support terminal according to claim 7, wherein the at least one second processor is further configured to execute the instructions to:
place an order of the article for which the selling price and the shop are notified by the notification unit.
